(19) United States
(12) Patent Application Publication
(10) Pub. No.: US 2016/0113282 A1
(43) Pub. Date: Apr. 28, 2016

(54) VIRUS DISINFECTANT CONTAINING CHLOROUS ACID AQUEOUS SOLUTION

(71) Applicant: HONBU SANKEI CO., LTD., Osaka-shi, Osaka (JP)

(72) Inventor: Hisataka GODA, Osaka (JP)

(21) Appl. No.: 14/892,333

(22) PCT Filed: May 15, 2014
(86) PCT No.: PCT/IB2014/061452

§ 371 Date: Nov. 19, 2015

(30) Foreign Application Priority Data
May 20, 2013 (JP) 2013-106200
Sep. 4, 2013 (JP) 2013-183114
Nov. 11, 2013 (JP) 2013-232958

(51) Int. Cl. A01N 59/00; A01N 25/34

(52) U.S. Cl. CPC A01N 59/00; A01N 25/34

(57) ABSTRACT

The present invention provides a safe virus disinfectant. Specifically, the present invention provides a virus disinfectant comprising a chlorous acid aqueous solution for inactivating viruses, such as at least one species of viruses selected from the group consisting of polioviruses, influenza viruses, herpesviruses, noroviruses, and feline caliciviruses. The virus disinfectant comprising a chlorous acid aqueous solution of the present invention can be utilized as a food additive, antiseptic, quasi-drug, medicine, or the like. Although there was an issue of sodium hypochlorite not being safe to a human body (high cytotoxicity), this has been resolved. Chlorous acid, which is safe for a human body and easy to handle and generates little chlorine dioxide, is produced as a virus disinfectant and a sterilizing agent for pretreatment in food processing. Chlorous acid is used as a virus disinfectant or a sterilizing agent.

The present invention relates to a virus disinfectant comprising a chlorous acid aqueous solution.

### BACKGROUND ART

The issues related to viral infections are old and new problems. One of the issues of viral infections is that there are many cases of inapparent infections (no outbreak at the time of infection). In other words, epidemic prevention is difficult because an individual with an inapparent infection can be a source of an infection.

The inventors have discovered a chlorous acid aqueous solution and a manufacturing method thereof. A sterilizing agent against E. coli was verified and a patent application therefor was filed (Patent Literature 1).

### CITATION LIST

### Patent Literature

### [PTL 1]

Patent Literature 1: International Publication No. WO 2008-026607

### SUMMARY OF INVENTION

### Solution to Problem

The present invention provides a virus disinfectant capable of unexpectedly and significantly disinfecting viruses extensively. The present invention also provides the following.
(1) A virus disinfectant comprising a chlorous acid aqueous solution.
(2) The virus disinfectant of (1), wherein the virus disinfectant inactivates at least one species of viruses selected from the group consisting of polioviruses, influenza viruses, herpesviruses, noroviruses, and feline caliciviruses.
(3) The virus disinfectant of (1) or (2), wherein the virus disinfectant is targeted for influenza viruses.
(4) The virus disinfectant according to any one of (1) to (3), wherein pH of the virus disinfectant is 6.5 or lower.
(5) The virus disinfectant according to any one of (1) to (4), wherein the virus disinfectant comprises chlorous acid at 200 ppm or higher.
(6) The virus disinfectant according to any one of (1) to (5), wherein the virus disinfectant is targeted for influenza viruses.
(7) The virus disinfectant according to any one of (1) to (6), wherein the virus disinfectant inactivates herpesviruses, wherein the virus disinfectant has pH of 5.5 or lower and a concentration of 50 ppm or higher.
(8) The virus disinfectant according to any one of (1) to (7), wherein the virus disinfectant inactivates polioviruses, wherein the virus disinfectant has pH of 7.5 or lower and a concentration of 500 ppm or higher.
(9) The virus disinfectant according to any one of (1) to (8), wherein the virus disinfectant inactivates noroviruses or feline caliciviruses, wherein the virus disinfectant has a concentration of 400 ppm or higher.
(10) The virus disinfectant according to any one of (1) to (9), wherein the chlorous acid aqueous solution has a significantly lower cytotoxic action even when compared at a concentration at which a virus disinfection effect of the chlorous acid aqueous solution is equivalent to a virus disinfection effect of sodium hypochlorite.
(11) The virus disinfectant according to any one of (1) to (10) for virus disinfection in the presence of an organic matter.
(12) An article impregnated with a chlorous acid aqueous solution for virus disinfection.
(13) The article of (12), wherein the article is selected from a sheet, film, patch, brush, nonwoven fabric, paper, fabric, absorbent cotton, and sponge.

Additional embodiments and advantages of the present invention are recognized by those skilled in the art if the following Detailed Description is read and understood as needed. In the present invention, one or more features described above are intended to be able to provide combinations that were explicitly described as well as combinations thereof. The additional embodiments and advantages of the present invention are recognized by those skilled in the art if the following Detailed Description is read and understood as needed.

### Advantageous Effects of Invention

According to the present invention, a virus disinfectant with high virus disinfecting capability is provided. Further, the present invention provides a virus disinfectant with suppressed chlorine dioxide generation, which can be reliably used and is safe in a human body. Such a virus disinfectant can be utilized as a virus disinfectant that can be widely used in clinical practice or the like.

The issues inherent in sodium hypochlorite and alcohol that exhibit virus disinfecting properties have been resolved. That is, although there was an issue of sodium hypochlorite not being safe to a human body (high cytotoxicity), this has been resolved. Further, when the alcohol concentration is 60% or higher, alcohol is hazardous and difficult to handle. In addition, when the concentration is less than 60%, it was difficult to obtain a virus disinfecting effect. However, a virus disinfectant that is equally or much safer and more powerful in comparison thereto is provided.

A chlorous acid aqueous solution has an excellent virus disinfecting effect against viruses that have become social issues, such as influenza viruses, herpesviruses, polioviruses, and noroviruses (feline caliciviruses) (see 2007 Norovirus no Fukatsuka Jokenni Kansuru Chosa Hokokusho [Investigative Report on Inactivation Conditions of Noroviruses], National Institute of Health Sciences, Division of Biomedical FoodResearch, Shigeki YAMAMOTO and Mamoru NODA, Japanese Ministry of Health, Labour and Welfare)

### BRIEF DESCRIPTION OF DRAWINGS

FIG. 1 is a diagram showing inactivation of influenza viruses by a chlorous acid aqueous solution. The protocol is shown on the right side and a graph plotting a relative value of the amount of infectious viruses against a chlorous acid concentration is shown on the left side. White circles indicate pH 5.5, white triangles indicate pH 6.5, white squares indicate pH 7.5, and black circles indicate 8.5.

FIG. 1B is a diagram showing the results from a sodium chlorite aqueous solution and an aqueous solution of a high-grade chlorinated lime formulation in a buffer with pH of 5.5 with inactivation concentration curves. In the diagram, the horizontal axis indicates concentrations (ppm) and the vertical axis indicates relative infectivity (25° C.). White circles indicate the sodium chlorite aqueous solution and white triangles indicate the aqueous solution of the high-grade chlorinated lime formulation.

FIG. 2A shows experimental examples for herpesviruses (Herpes simplex virus type I VR-539) with respect to a buffer at each pH range. The protocol is shown on the left side and survival rates in a buffer are shown in the graph on the right side (control only having a buffer).

FIG. 2B shows experimental examples (continuation of FIG. 2A) for herpesviruses (Herpes simplex virus type I VR-539) with respect to a chlorous acid aqueous solution. A chlorous acid aqueous solution is shown in the top left corner, sodium hypochlorite is shown in the top right corner, and sodium chlorite is shown in the bottom left corner.

FIG. 3 shows inactivation of polioviruses by a chlorous acid aqueous solution (compared to inactivation of influenza viruses). The protocol is shown on the right side, and a graph plotting a relative value of the amount of infectious viruses against a chlorous acid concentration is shown on the left side. White circles indicate influenza viruses at pH 5.5, white triangles indicate influenza viruses at pH 7.5, black circles indicate polioviruses at pH 5.5, and black triangles indicate polioviruses at pH 7.5.

FIG. 3B shows a quantitative analysis of poliovirus inactivation action by a chlorous acid aqueous solution. The horizontal axis indicates concentrations (ppm). White circles indicate influenza viruses (pH 5.5), black circles indicate polioviruses (pH 5.5), white triangles indicate influenza viruses (pH 7.5), and black triangles indicate polioviruses (pH 7.5).

FIG. 4 shows the rate of influenza virus inactivation by a chlorous acid aqueous solution. The protocol is shown on the right side and a graph plotting a relative value of the amount of infectious viruses against time (minutes) is shown on the left side.

FIG. 5 shows a comparison between cytotoxic action of a chlorous acid aqueous solution and that of sodium hypochlorite. The protocol is shown on the right and the results are shown on the left. The left graph shows a graph plotting the ratio of dead cells against a concentration of the chlorous acid aqueous solution or sodium hypochlorite.

FIG. 6 shows a comparison between cytotoxic action of a chlorous acid aqueous solution and that of sodium hypochlorite from another viewpoint. The protocol is shown on the right and the results are shown on the left. The left graph shows a graph plotting the ratio of dead cells against a concentration of the chlorous acid aqueous solution or sodium hypochlorite.

FIG. 7 shows a comparison between cytotoxic action of a chlorous acid aqueous solution and that of sodium hypochlorite in terms of impairment in colony formation capability of each of Vero cells, HEp-2 cells, and MDCK cells as yet another viewpoint. The graph shows the effects in a phosphoric acid buffer.

FIG. 8 shows concentrations that inactivate feline caliciviruses in a diluent of “chlorous acid aqueous solution”. The diagram shows chlorous acid concentration, which is the chlorous acid concentration in a diluent of a chlorous acid aqueous solution (ppm).

FIG. 9 shows inactivation action on feline caliciviruses by a chlorous acid aqueous solution. White circles indicate pH of 5.5, white triangles indicate pH of 6.5, white squares indicate pH of 7.5, and black circles indicate pH of 8.5.

FIG. 10 shows inactivation action on feline caliciviruses by a chlorous acid aqueous solution formulation. White circles indicate a chlorous acid aqueous solution at pH of 4.5 and white triangles indicate a chlorous acid aqueous solution at pH of 7.5. Black circles indicate sodium hypochlorite at pH of 4.5 and black triangles indicate sodium hypochlorite at pH of 7.5.

FIG. 11 shows virus inactivation by a chlorous acid aqueous solution formulation in 10% miso. White circles indicate feline caliciviruses and white triangles indicate influenza viruses.

FIG. 12 shows chronological changes in inactivation of feline caliciviruses by a chlorous acid aqueous solution formulation in 10% miso. White circles indicate five minute treatment and white triangles indicate 20 minute treatment.

FIG. 13 shows pictures of plaques of Examples 10 and 11.

FIG. 14 shows a graph of absorbance and wavelength in confirmation test (2) in Table 2.

FIG. 15 shows a graph of absorbance and wavelength in confirmation test (2) in Table 4.

FIG. 16 shows the result of making an inactivation concentration curve with respect to feline caliciviruses in an organic matter (10% miso) by plotting the results of Example 12 with residual infectivity titer of feline caliciviruses (y axis) and chlorous acid concentration (ppm) (x axis).

FIG. 17 shows the result of making an inactivation concentration curve with respect to influenza viruses in an organic matter (10% miso) by plotting the results of Example 12 with residual infectivity titer of influenza viruses (y axis) and chlorous acid concentration (ppm) (x axis).

### DESCRIPTION OF EMBODIMENTS

The present invention is described below. Throughout the entire specification, a singular expression should be understood as encompassing the concept thereof in a plural form unless specifically noted otherwise. Thus, singular articles (e.g., “a”, “an”, the and the like in case of English) should be understood as encompassing the concept thereof in a plural form unless specifically noted otherwise. Further, the terms used herein should be understood as being used in the meaning that is commonly used in the art, unless specifically noted otherwise. Thus, unless defined otherwise, all terminologies and scientific technical terms that are used herein have the same meaning as the terms commonly understood by those skilled in the art to which the present invention belongs. In case of a contradiction, the present specification (including the definitions) takes precedence.

Herein, “antiviral (action)” refers to suppression of viral growth. A substance having antiviral action is referred to as an antiviral agent.

Herein, “virucidal (action)” refers to inactivation of infectivity of viral particles. Virus inactivation is considered to be due to a change in a conformational structure of a viral particle constituent, such as a nucleic acid protein or a lipid, or due to modulation in interaction therebetween. A substance having virucidal action is referred to as a virucidal agent.

Herein, “virus disinfection (action)” refers to a broad concept including antiviral action and virucidal action. A “virus disinfectant” refers to any agent that has antiviral action or virucidal action. A virus disinfectant can be used as a medicine, quasi-drug, food additive, antiseptic or the like.

In principle, an antiviral agent acts on a specific virus, whereas a virucidal agent is effective against a wide variety of viruses. Use of an antiviral agent always produces a drug-resistant viral mutant strain. However, a virucidal agent in principle does not produce a drug-resistant viral strain. This is because a virucidal agent has multiple target molecules. Thus, a virucidal agent is preferable in that resistance therefor does not arise. As a method of measuring action of a virucidal agent, the following test is typically used.
1) 180 μl of buffer with a designated pH is added to a 2 ml plastic tube (assist tube).
2) 10 μl of chlorous acid aqueous solution with a designated concentration is added.
3) After adding 10 μl of viral solution and sufficiently agitating, the mixture is incubated in a thermostatic water bath at a designated temperature.
4) Immediately after incubation, the mixture is cooled in ice water and diluted 100-fold with a viral diluent containing proteins.
5) The amount of residual infectious viruses is measured by a plaque assay.

Any virus can be a virus which is targeted by the present invention. For example, said virus includes influenza viruses, herpesviruses, polioviruses, noroviruses, and feline caliciviruses.

An influenza virus, which the present invention targets, is an RNA virus that has an envelope. Although there are different types of influenza viruses such as Type A and Type B, the present invention can target any type of influenza virus. It is possible to use the influenza virus Type A Aichi strain as a typical test strain, but a test strain is not limited thereto.

A norovirus is a genus of viruses that induces a bacterial acute gastroenteritis. In addition to causing food poisoning from intake of shellfish such as oysters, a norovirus can orally infect through excrement or vomit of an infected human or through dust particles from the dried excrement or vomit of the infected human. When testing noroviruses, a related species, feline caliciviruses, is used. Tests with such a related species are approved in the art. For noroviruses, please refer to Norovirus Fukatsuka Yukosei Hyoka Shiken ni okeru Daikan Virus, Nekokarisi Virus Shiyo ni yoru Shikenho [Testing method using a substitute virus, feline calicivirus, in inactivation effectiveness assessment test on norovirus], EPA and 2007 Norovirus no Fukatsuka Jokenni Kansuru Chosa Hokokusho [Investigative Report on Inactivation Conditions of Norovirus], National Institute of Health Sciences, Division of Biomedical FoodResearch, Shigeki YAMAMOTO and Mamoru NODA, Japanese Ministry of Health, Labour and Welfare. For a virucidal effect of noroviruses, an investigation is deemed replaceable with an investigation using related bacteria, feline calicivirus (FCV) (In addition to the above references, Gehrke, C et al: Inactivation of feline calicivirus, a surrogate of norovirus (formerly Norwalk-like viruses), by different types of alcohol in vitro and in vivo, J Hosp Infect (2004) 46:49-55; Doultree, J C et al: Inactivation of feline calicivirus, a norwalk virus surrogate, J Hosp Infect (1999) 41:51-57); Jennifer, L et al: Surrogates for the study of norovirus stability and inactivation in the environment: A comparison of murine norovirus and feline calicivirus, J Food Protect (2006) 11:2761-2765; Hirotaka TAKAGI et al: Neko Calicivirus (FCV) wo Daikan to shita Norovirus (NV) Fukatsuka Koka no Kento-Arukarizai, Kasankasuiso, and Katansan Natoriumu ni yoru Fukasseika Koka-[Investigation of Inactivation Effect onNorovirus (NV) with Feline Caliciviruses (FCV) as a Substitute-Inactivation Effect by Alkaline Agent, Hydrogen Peroxide, and Sodium Percarbonate], Japanese Journal of Medicine and Pharmaceutical Science (2007) 57:311-312). These references are incorporated herein by reference.

A herpesvirus is a type of DNA viruses. A herpesvirus includes HSV-1 (Herpes simplex virus type 1) and HSV-2 (Herpes simplex virus type 2), but is not limited thereto. A representative herpes virus strain includes Herpes simplex virus type I VR-539, but is not limited thereto.

In a herpesvirus survival test, herpesviruses are typically anaerobically cultured for 30 minutes at 25° C., the surviving viruses are allowed to infect Vero cells (one hour), and the number of plaques is measured to determine a survival rate.

A chlorous acid aqueous solution has a sterilizing effect on herpesvirus type I. The effect is demonstrated to be significant under acidic conditions, preferably at pH of 5.5 or lower. It is believed that a concentration of 50 ppm or higher is preferably needed in order to obtain a sufficient sterilizing effect.

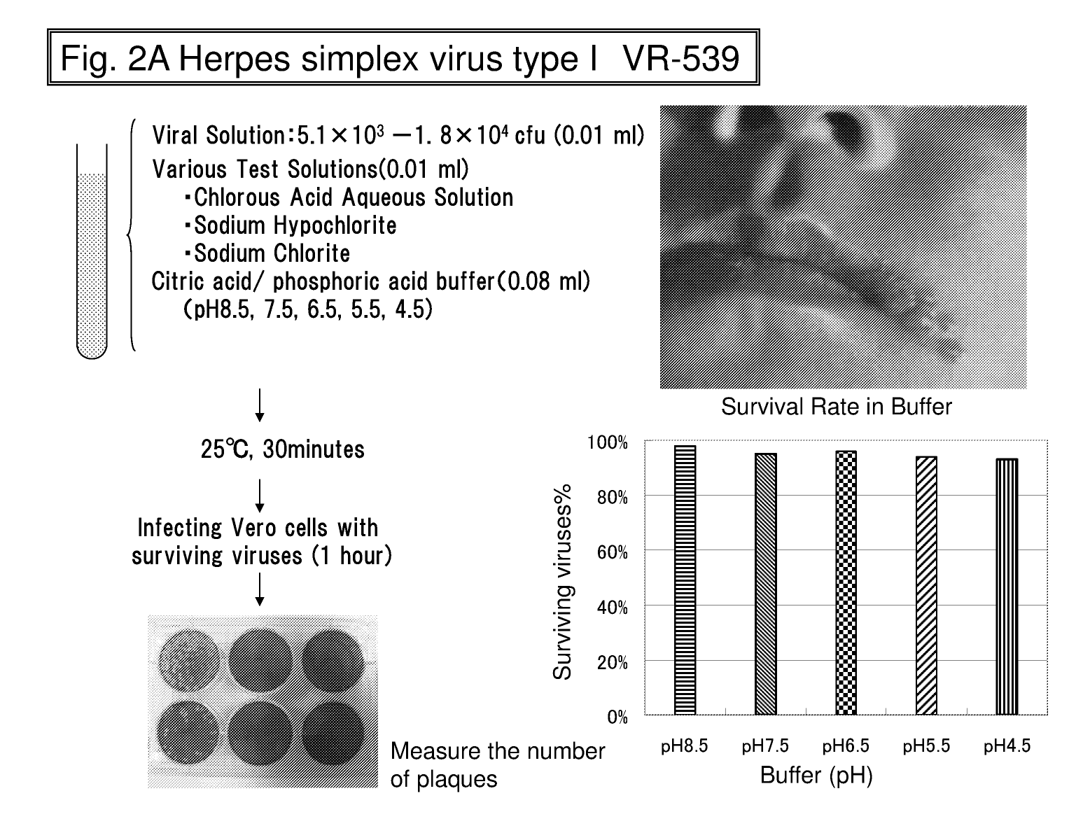

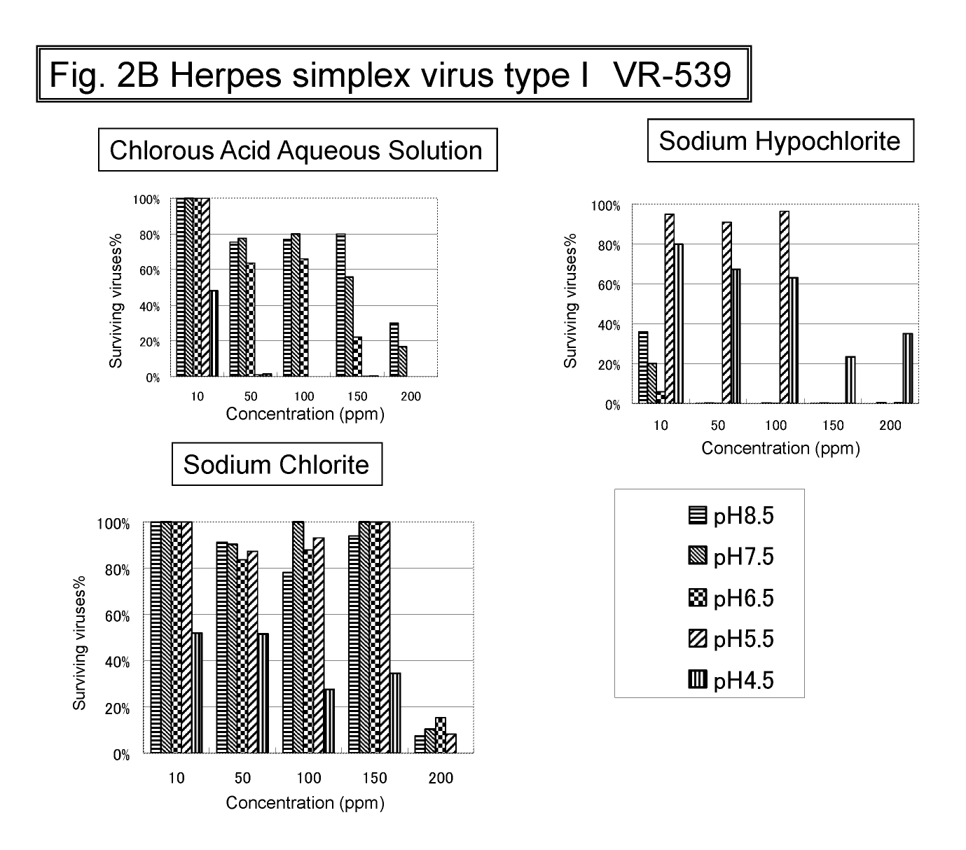

For sodium hypochlorite, a sterilizing effect on herpesvirus type I diminishes under acidic conditions with pH at 5.5 or higher. Thus, enhancement in sterilizing effect under acidic conditions with a chlorous acid aqueous solution is recognized as an unexpected effect (e.g., FIG. 2B).

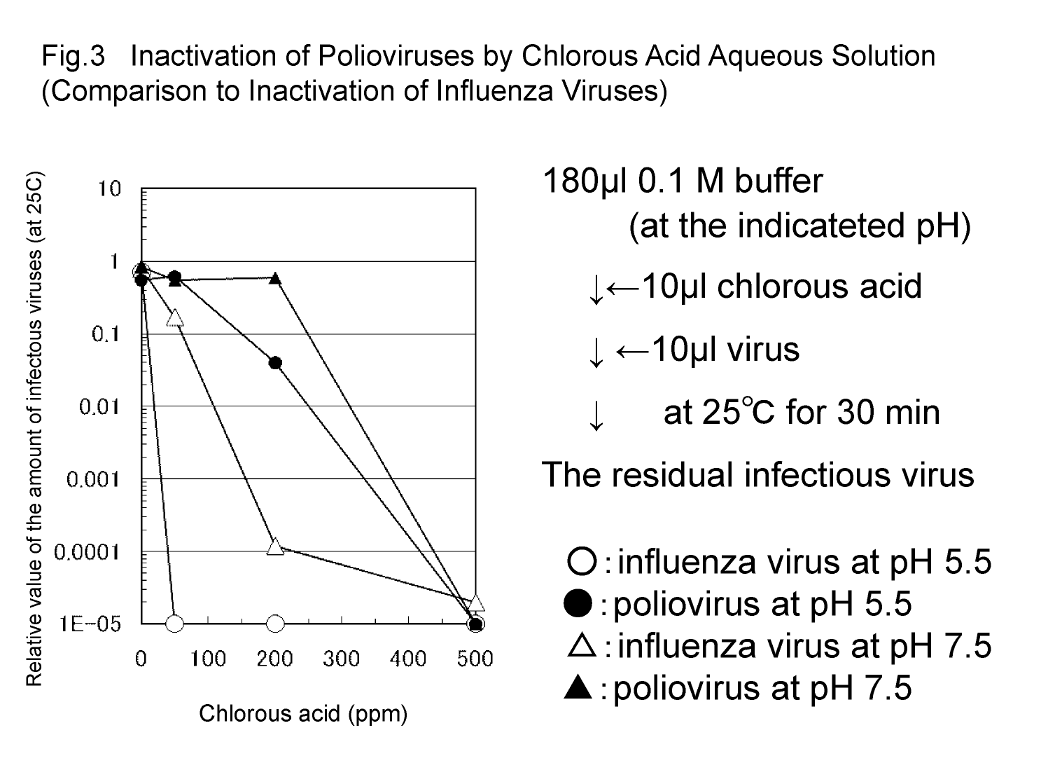

Polioviruses are viruses of Enterovirus genus in the Picornaviridae family. Polioviruses are the cause of acute poliomyelitis, which is called polio. In the present invention, it was found that polioviruses can also be inactivated with a chlorous acid aqueous solution (e.g., FIG. 3).

The rate of inactivating viruses (e.g., influenza viruses) by the chlorous acid aqueous solution of the present invention can be determined by conducting a normal experiment (mixing, etc.) and measuring the amount of remaining infectious viruses. Influenza viruses can be completely inactivated by a contact of one minute or less with a chlorous acid aqueous solution having 5 ppm as the chlorous acid concentration under the condition of pH 6.5 (e.g., FIG. 4).

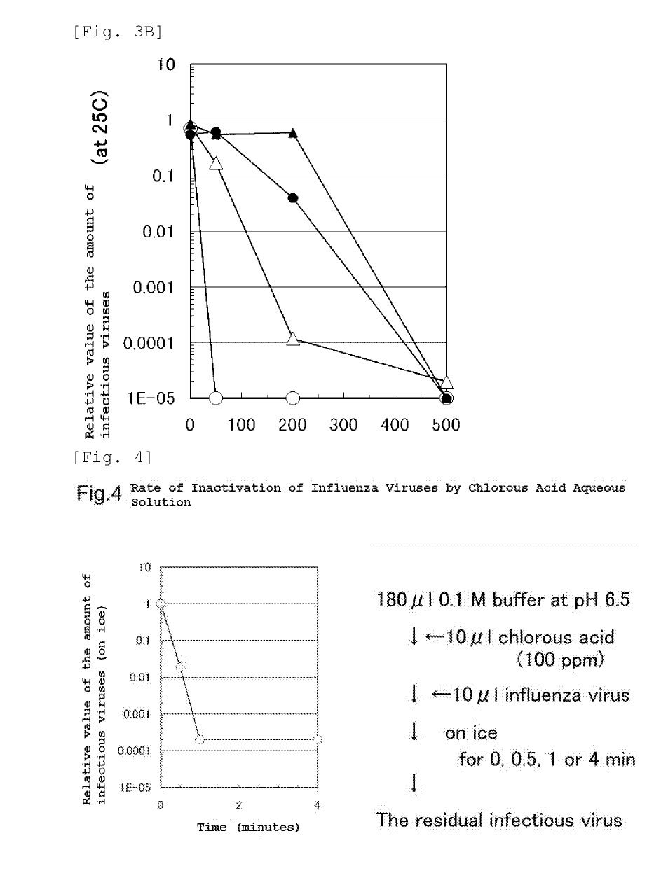

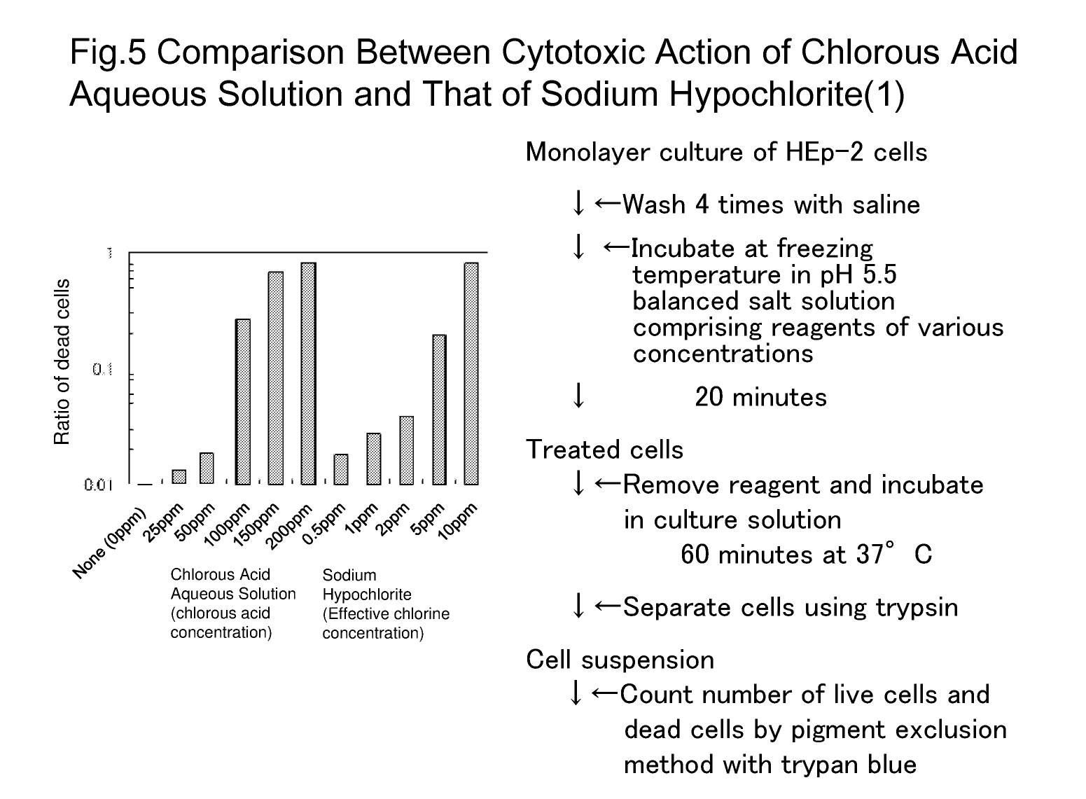

In a comparison between cytotoxic action of a chlorous acid aqueous solution and that of sodium hypochlorite, for example, when HEp-2 cells are used, sodium hypochlorite at about 0.5 ppm resulted in dead cells. However, for the chlorous acid aqueous solution of the present invention at 50 ppm, only about the same number of dead cells was confirmed as sodium hypochlorite at 0.5 ppm. Thus, the effect of the chlorous acid aqueous solution is about 1/100 of sodium hypochlorite, which is equivalent to having virtually no effect. Further, for herpesvirus disinfection effects of a chlorous acid aqueous solution, virus disinfection effects have been found in FIG. 2B to be equivalent at a concentration of 50 ppm on the acidic side of a chlorous acid aqueous solution and at a concentration at 50 ppm on the alkaline side of sodium hypochlorite. However, even with equivalent virus disinfection effects, cytotoxic action of the chlorous acid aqueous solution was about 1/100 of that of sodium hypochlorite (FIG. 5). From the above, a chlorous acid aqueous solution is understood as capable of providing a safe antiseptic virus disinfectant due to its safety (low toxicity) on cells. Further, since a chlorous acid aqueous solution does not remain in a virus or cell, a resistant virus is generally not produced. Thus, a chlorous acid aqueous solution is also effective in terms of an ultimate viral disinfection that does not give rise to resistance.

### (Chlorous Acid Aqueous Solution and Manufacturing Example Thereof)

The chlorous acid aqueous solution used in the present invention has a feature that was discovered by the inventors. A chlorous acid aqueous solution manufactured by any method, such as known manufacturing methods described in Patent Literature 1, can be used. It is possible to mix and use an agent with, for example, 61.40% chlorous acid aqueous solution, 1.00% potassium dihydrogen phosphate, 0.10% potassium hydroxide, and 37.50% purified water, as a typical constitution (scheduled to be sold under the name “AUTOLOC Super” by the Applicant), but the constitution is not limited thereto. The chlorous acid aqueous solution may be 0.25%-75%, potassium dihydrogen phosphate may be 0.70%-17.42%, and potassium hydroxide may be 0.10%-5.60%. It is possible to use sodium dihydrogen phosphate instead of potassium dihydrogen phosphate, and sodium hydroxide instead of potassium hydroxide. This agent can reduce the decrease of chlorous acid due to contact with an organic matter under acidic conditions. However, the cytotoxic effect is retained. Further, the present invention has demonstrated that a virus disinfection effect is retained. In addition, very little chlorine gas is generated. Further, the agent also has a feature of inhibiting amplification of odor from mixing chlorine and an organic matter.

In one embodiment, the chlorous acid aqueous solution of the present invention can be produced by adding and reacting sulfuric acid or an aqueous solution thereof to a sodium chlorate aqueous solution in an amount and concentration at which the pH value of the sodium chlorate aqueous solution can be maintained at 3.4 or lower to generate chloric acid, and subsequently adding hydrogen peroxide in an amount equivalent to or greater than the amount required for a reduction reaction of the chloric acid.

Further, in another embodiment, the chlorous acid aqueous solution of the present invention can be produced from adding one compound from inorganic acids or inorganic acid salts, two or more types of compounds therefrom, or a combination thereof to an aqueous solution, in which chlorous acid is produced by adding and reacting sulfuric acid or an aqueous solution thereof to a sodium chlorate aqueous solution in an amount and concentration at which the pH value of the sodium chlorate aqueous solution can be maintained at 3.4 or lower to generate chloric acid, and subsequently adding hydrogen peroxide in an amount equivalent to or greater than the amount required for a reduction reaction of the chloric acid, and adjusting the pH value within the range from 3.2 to 8.5.

Furthermore, in another embodiment, the chlorous acid aqueous solution of the present invention can be produced from adding one compound from inorganic acids or inorganic acid salts or organic acids or organic acid salts, two or more types of compounds therefrom, or a combination thereof to an aqueous solution, in which chlorous acid is produced by adding and reacting sulfuric acid or an aqueous solution thereof to a sodium chlorate aqueous solution in an amount and concentration at which the pH value of the sodium chlorate aqueous solution can be maintained at 3.4 or lower to generate chloric acid, and subsequently adding hydrogen peroxide in an amount equivalent to or greater than the amount required for a reduction reaction of the chloric acid, and adjusting the pH value within the range from 3.2 to 8.5.

Further still, in another embodiment, the chlorous acid aqueous solution of the present invention can be produced from adding one compound from inorganic acids or inorganic acid salts or organic acids or organic salts, two or more types of compounds therefrom, or a combination thereof after adding one compound from inorganic acids or inorganic acid salts, two or more types of compounds therefrom or a combination thereof to an aqueous solution, in which chlorous acid is produced by adding and reacting sulfuric acid or an aqueous solution thereof to a sodium chlorate aqueous solution in an amount and concentration at which the pH value of the sodium chlorate aqueous solution can be maintained at 3.4 or lower to generate chloric acid, and subsequently adding hydrogen peroxide in an amount equivalent to or greater than the amount required for a reduction reaction of the chloric acid, and adjusting the pH value within the range from 3.2 to 8.5.

Further, in another embodiment, carbonic acid, phosphoric acid, boric acid, or sulfuric acid can be used as the inorganic acid in the above-described method.

Further still, in another embodiment, carbonate, hydroxy salt, phosphate or borate can be used as the inorganic acid salt.

Further, in another embodiment, sodium carbonate, potassium carbonate, sodium bicarbonate or potassium bicarbonate can be used as the carbonate.

Furthermore, in another embodiment, sodium hydroxide, potassium hydroxide, calcium hydroxide, or barium hydroxide can be used as the hydroxy salt.

Further still, in another embodiment, disodium hydrogen phosphate, sodium dihydrogen phosphate, trisodium phosphate, tripotassium phosphate, dipotassium hydrogen phosphate, or potassium dihydrogen phosphate can be used as the phosphate.

Further, in another embodiment, sodium borate or potassium borate can be used as the borate.

Furthermore, in another embodiment, succinic acid, citric acid, malic acid, acetic acid, or lactic acid can be used as the organic acid.

Further still, in another embodiment, sodium succinate, potassium succinate, sodium citrate, potassium citrate, sodium malate, potassium malate, sodium acetate, potassium acetate, sodium lactate, potassium lactate, or calcium lactate can be used as the organic acid salt.

In a method of manufacturing an aqueous solution comprising chlorous acid (HClO₂) that can be used as a sterilizing agent or a virus disinfectant (chlorous acid aqueous solution), chlorous acid (HClO₂) is produced by adding hydrogen peroxide (H₂O₂) in an amount required to produce chlorous acid by a reducing reaction of chloric acid (HClO₃) obtained by adding sulfuric acid (H₂SO₄) or an aqueous solution thereof to an aqueous solution of sodium chlorate (NaClO₃) so that the aqueous solution of sodium chlorate is in an acidic condition. The basic chemical reaction of this method of manufacturing is represented by the following formula A and formula B.

[Chemical 1]

2NaClO₃+H₂SO₄→2HClO₃+Na₂SO₄ (formula A)

HClO₃+H₂O₂→HClO₂+H₂O+O₂↑ (formula B)

Formula A indicates that chloric acid is obtained by adding sulfuric acid (H₂SO₄) or an aqueous solution thereof in an amount and concentration at which the pH value of a sodium chlorate (NaClO₃) aqueous solution can be maintained within acidity. Next, formula B indicates that chloric acid (HClO₃) is reduced by hydrogen peroxide (H₂O₂) to produce chlorous acid (HClO₂).

[Chemical 2]

HClO₃+H₂O₂→2ClO₂+H₂O+O₂ (formula C)

2ClO₂+H₂O₂→2HClO₂+O₂␣ (formula D)

2ClO₂+H₂O [symbol] HClO₂+HClO₃ (formula E)

2HClO₂ [symbol] H₂O+Cl₂O₃ (formula F)

At this time, chlorine dioxide gas (ClO₂) is generated (formula C). However, from coexisting with hydrogen peroxide (H₂O₂), chlorous acid (HClO₂) is produced through the reactions in formulae D-F.

Meanwhile, the produced chlorous acid (HClO₂) has a property such that it is decomposed early into chlorine dioxide gas or chlorine gas due to the presence of chloride ion (Cl⁻) or hypochlorous acid (HClO) and other reduction substances and a decomposition reaction occurring among a plurality of chlorous acid molecules with one another. Thus, it is necessary to prepare chlorous acid (HClO₂) so that the state of being chlorous acid (HClO₂) can be sustained for an extended period of time in order to be useful as a sterilizing agent or a virus disinfectant.

In this regard, chlorous acid (HClO₂) can be stably sustained over an extended period of time from creating a transition state to delay a decomposition reaction by adding one compound from inorganic acids, inorganic acid salts, organic acids or organic acid salts, two or more types of compounds therefrom, or a combination thereof to the chlorous acid (HClO₂) or chlorine dioxide gas (ClO₂) obtained by the above-described method or an aqueous solution containing them.

In one embodiment, it is possible to utilize a mixture in which one compound from inorganic acids or inorganic acid salts, specifically carbonate or hydroxy salt, two or more types of compounds therefrom or a combination thereof is added to the chlorous acid (HClO₂) or chlorine dioxide gas (ClO₂) obtained by the above-described method or an aqueous solution containing them.

In another embodiment, it is possible to utilize a mixture in which one compound from inorganic acids, inorganic acid salts, organic acids, or organic acid salts, two or more types of compounds therefrom, or a combination thereof is added to an aqueous solution to which one compound from inorganic acids or inorganic acid salts, specifically carbonate or hydroxy salt, two or more types of compounds therefrom, or a combination thereof is added.

Additionally, in another embodiment, it is possible to utilize a mixture in which one compound from inorganic acids or inorganic acid salts or organic acids or organic acid salts, two or more types of compounds therefrom, or a combination thereof is added to the aqueous solution manufactured by the above-described method.

Carbonic acid, phosphoric acid, boric acid, or sulfuric acid can be used as the above-described inorganic acid. Further, besides carbonate or hydroxy salt, phosphate or borate can be used as the inorganic acid salt. Specifically, sodium carbonate, potassium carbonate, sodium bicarbonate or potassium bicarbonate works well in use as the carbonate; sodium hydroxide, potassium hydroxide, calcium hydroxide, or barium hydroxide works well in use as the hydroxy salt; disodiumhydrogen phosphate, sodium dihydrogen phosphate, trisodium phosphate, tripotassium phosphate, dipotassium hydrogen phosphate, or potassium dihydrogen phosphate works well in use as the phosphate; and sodium borate or potassium borate works well in use as the borate. Furthermore, succinic acid, citric acid, malic acid, acetic acid, or lactic acid can be used as the organic acid. Further, sodium succinate, potassium succinate, sodium citrate, potassium citrate, sodium malate, potassium malate, sodium acetate, potassium acetate, sodium lactate, potassium lactate, or calcium lactate is suitable as the organic acid salt.

When an acid and/or a salt thereof is added, a transition state, such as Na⁺+ClO₂⁻<−>Na—ClO₂, K⁺+ClO₂<−>K—ClO₂, or H⁺+ClO₂⁻<−>H—ClO₂ can be temporarily created. This contributes to a delay in the progression of chlorous acid (HClO₂) to chlorine dioxide (ClO₂), which enables the manufacture of an aqueous solution comprising chlorous acid (HClO₂) that sustains chlorous acid (HClO₂) for an extended time and generates a reduced amount of chlorine dioxide (ClO₂).

The following represents the decomposition of chlorite in an acidic aqueous solution.

[Chemical 3]

5ClO₂⁻+4H⁺→4ClO₂+5Cl⁻+2H₂O (a)

(5NaClO₂+4CH₃COOH→4ClO₂+4CH₃COONa+NaCl+2H₂O)3ClO₂⁻→2ClO₃⁻+Cl⁻ (b)

(3NaClO₂→2NaClO₃+NaCl)^{Autodecomposition}ClO₂⁻→Cl⁻+2O (c)

As represented in the formula, the rate of decomposition of a chlorite aqueous solution is greater when pH is lower, i.e., more acidic. That is, the absolute rates of the reactions (a), (b), and (c) in the above-described formula increase. For example, although the ratio accounted for by reaction (a) decreases when pH is lower, the total decomposition rate changes significantly, i.e., to a larger value. Thus, the amount of generated chlorine dioxide (ClO₂) increases with the decrease in pH. Thus, the lower the pH value, sooner the virus disinfection takes effect. However, stimulatory and harmful chlorine dioxide gas (ClO₂) renders an operation more difficult and negatively affects the health of a human being. Further, a reaction of chlorous acid to chlorine dioxide progresses quicker to render chlorous acid unstable. In addition, the time a virus disinfection effect can be sustained is very short.

In one aspect, the present invention provides a virus disinfectant comprising a chlorous acid aqueous solution. In the present invention, when the above-described inorganic acids, inorganic acid salts, organic acids or organic acid salts are added to an aqueous solution comprising chlorous acid (HClO₂), pH values are adjusted in the range of 3.2-8.5 from the viewpoint of balancing suppression of chlorine dioxide generation and virus disinfection effect. For example, with respect to virus disinfection, pH may be 6.5 or lower for influenza viruses in a preferred embodiment. Further, the optimum pH was 5.5 or lower for herpesviruses. In any case, the present invention provides a virus disinfectant comprising a chlorous acid aqueous solution for any type of virus. Although it is not desired to be constrained by theory, since all viruses were able to be similarly disinfected when effects on various viruses were tested herein, it is due to the fact that the virus disinfectant of the present invention is understood to be capable of disinfection regardless of the type of virus, in view of the principle of disinfection thereof. That is, a virus disinfection effect is an inactivation effect by chlorous acid, and such an effect is considered to be non-dependent on the type of virus. Thus, a virus disinfectant for which resistance does not arise can be provided. Further, since the chlorous acid aqueous solution of the present invention decomposes after use, it is also possible to conclude that resistance thereto does not in principle arise with respect to this point. Thus, the chlorous acid aqueous solution of the present invention is recognized as an ideal virus disinfectant.

The present invention is capable of disinfecting at least polioviruses, influenza viruses, herpesviruses, noroviruses, and feline caliciviruses, which have become a social issue. Thus, the present invention is highly effective with respective to this point. It is advantageous if pH is preferably 6.5 or higher, but the pH is not limited thereto. Further, it is preferable but not limited to contain chlorous acid at 200 ppm or higher. These conditions are especially effective against influenza viruses, but not limited thereto.

In one embodiment, the present invention is for inactivating polioviruses, preferably with, but not limited to, pH of 5.5 or lower and concentration of 50 ppm or higher.

In another embodiment, the present invention is for inactivating polioviruses, preferably with, but not limited to, pH of 7.5 or lower and concentration of 500 ppm or higher.

In yet another embodiment, the present invention is for inactivating noroviruses or feline caliciviruses, preferably with, but not limited to, a concentration of 400 ppm or higher.

In yet another embodiment, the following can be one of the characteristics of the virus disinfectant of the present invention: a chlorous acid aqueous solution has a significantly lower cytotoxic action, even when compared at a concentration having a virus disinfection effect equivalent to a virus disinfection effect of sodium hypochlorite.

In one aspect, the present invention provides a virus disinfectant comprising a chlorous acid aqueous solution for disinfecting viruses in the presence of an organic matter.

The virus disinfectant of the present invention can be in any form that can be impregnated with a chlorous acid aqueous solution for use in virus disinfection or the like, including a medicine, quasi-drug, food additive, and medical device. A spray, liquid agent, gel agent and the like can also be mentioned, but the form is not limited thereto.

In another aspect, the present invention provides an article impregnated with a chlorous acid aqueous solution for disinfecting viruses. There are not that many sterilizing agents capable of disinfecting viruses. In addition, there is no residual odor. Thus, the article is preferred for use in treating a floor surface or the like that requires maintenance of environment. Further, since it is in principle difficult for resistance to arise, the present invention is used as a preferred virus disinfectant or article.

An article that can be used as the article for disinfecting viruses of the present invention are any article that can be impregnated with a chlorous acid aqueous solution for use in disinfecting viruses or the like, including medical devices and the like. A sheet, film, patch, brush, nonwoven fabric, paper, fabric, absorbent cotton, sponge and the like are examples thereof, but the article is not limited thereto. In a preferred embodiment, chlorous acid is impregnated at a concentration of 1000 ppm or higher, preferably at 3000 ppm, and still preferably at 4000 ppm, but the concentration is not limited thereto. For virus disinfection, a sufficient disinfection effect is observed at 1000 ppm. However, when expecting a long term effect, it is preferable at 3000 ppm or 4000 ppm because the effect is higher. The material of an article is not limited, and any material may be used as long as the material is capable of absorbing and retaining a chlorous acid aqueous solution and is capable of being applied to the article. In one embodiment, the sheet of the present invention is made of cotton.

Any reference document cited herein, such as a scientific article, patent and patent application, is incorporated by reference in the present specification in the same manner as the entire contents are specifically described therein.

As described above, the present invention has been explained while presenting preferable embodiments to facilitate understanding. Hereinafter, the present invention is explained based on the Examples. However, the aforementioned explanation and the following Examples are provided solely for exemplification, not for limiting the present invention. Thus, the scope of the present invention is not limited to the Embodiments or Examples that are specifically described herein. The scope of the present invention is limited solely by the scope of the claims.

### EXAMPLES

When necessary, animals used in the following Examples were handled in compliance with the Declaration of Helsinki. For reagents, the specific products described in the Examples were used. However, the reagents can be substituted with an equivalent product from another manufacturer (Sigma, Wako Pure Chemical Industries, Nacalai Tesque, or the like).

(Representative Cells and Viruses that were Used)

In the present Example, the following representative viruses and cells were used.

### (Virus)

Influenza viruses (RNA viruses with an envelope): Influenza virus Type A Aichi strain was from the University of Tokushima, Faculty of Medicine, Virology Class.

Herpesviruses (DNA viruses with an envelope): Herpesvirus type I (HSV-1) was purchased from American Type Culture Collection (ATCC).

Polioviruses (RNA viruses with a shell consisting of proteins): Poliovirus type I live vaccine strain was from the University of Tokushima, Faculty of Medicine, Virology Class.

Feline caliciviruses (for testing noroviruses): Feline calicivirus F4 strain was obtained from the National Institute of Infectious Diseases, Department of Virology II.

### (Cells)

MDCK cells (established cell line derived from a canine kidney): MDCK cells were used for growing and quantifying influenza viruses, and the cells were from the University of Tokushima, Faculty of Medicine, Virology Class.

HEp-2 cells (from human cervical cancer): HEp-2 cells were used for growing HSV-1 and polioviruses, and the cells were from the University of Tokushima, Faculty of Medicine, Virology Class.

Vero cells (from the kidney of an African green monkey): Vero cells were used for quantifying HSV-1 and polioviruses, and the cells were purchased from American Type Culture Collection (ATCC).

CRFK cells: CRFK cells were used for culturing and quantifying feline caliciviruses and the cells were obtained from the National Institute of Infectious Diseases, Department of Virology II.

### (Quantification Method of Chlorous Acid Aqueous Solution)

5 g of the present product is precisely measured. Water is added thereto so that the solution is exactly 100 ml. After 20 ml of the sample solution is accurately measured, put in an iodine flask, and added with 10 ml of sulfuric acid (1-10), 1 g of potassium iodide is added thereto. The flask is immediately sealed and shaken well. A potassium iodide test solution is poured into the top portion of the iodine flask and left standing in the dark for 15 minutes. The plug is then loosened to pour in a potassium iodide test solution and sealed immediately. After sealing and shaking the flask well, freed iodine is titrated with 0.1 mol/L sodium thiosulfate (indicator, starch indicator). The indicator is added after the color of the solution has changed to a light yellow color. A blank test is separately conducted for correction (1 mL of 0.1 mol/L sodium thiosulfate solution=1.711 mg of HClO₂).

### Example 1

### Production of Chlorous Acid Aqueous Solution

The chlorous acid aqueous solution formulation used in the following Example was produced as follows. There are cases herein where an abbreviation “CAAS” is used for a chlorous acid aqueous solution. However, they have the same meaning.

### Component Analysis Table for Chlorous Acid Aqueous Solution

TABLE 2

| | | Match/Not a |
|---|---|---|
| CAAS specification | Specification Value | Match |
| Content | 4-6% | 4.1% |
| Attribute | light yellowish green to | yellowish red |
| | yellowish red | |
| Confirmation Test | When 0.1 ml of potassium | Match |
| (1) | permanganate aqueous | |
| | solution (1→300) is | |
| | added to 5 ml of an | |
| | aqueous solution of the | |
| | present product (1→20), | |
| | the solution turns | |
| | reddish purple. When 1 ml | |
| | of sulfuric acid (1→20) | |
| | is added thereto, the | |
| | solution turns light | |
| | yellow. | |
| Confirmation Test | An aqueous solution of | Match |
| (2) | the present product | The graph for |
| | (1→20) has portions of | absorbances |
| | maximum absorbance at | and |
| | wavelengths 258 nm-262 nm | wavelengths |
| | and 346-361 nm. | is shown in |
| | | FIG. 14. |
| Confirmation Test | If potassium iodide | Match |
| (3) | starch paper is dipped in | |
| | the present product, the | |
| | potassium iodide starch | |
| | paper changes to a blue | |
| | color and then the color | |
| | fades | |
| Purity Test (1) | 1.0 μg/g or lower for lead | Below |
| | | detectable |
| | | limit |
| Purity Test (2) | 1.0 μg/g or lower for | Below |
| | As₂O₃ | detectable |
| | | limit |

A chlorous acid aqueous solution formulation was manufactured using this chlorous acid aqueous solution based on the following blend. The final pH was 6.5.

TABLE 3

| | | Blended | | Acceptable |
|---|---|---|---|---|
| | Raw material | Amount | Concentration | Range |
| 1 | Tap water | 258.0 g | | |
| 2 | Dipotassium | 17.0 g | 1.70% | 0.70%-13.90% |
| | hydrogen | | | |
| | phosphate | | | |
| 3 | Potassium | 5.0 g | 0.50% | 0.10%-5.60% |
| | hydroxide | | | |
| 4 | Chlorous acid | 720.0 g | 72.00% | 0.25%-75% |
| | aqueous solution | | | |
| | (pH 3.5) | | | |

| | | |
|---|---|---|
| Total | Chlorous | 1000 g |
| | acid | |
| | 30000 ppm | |

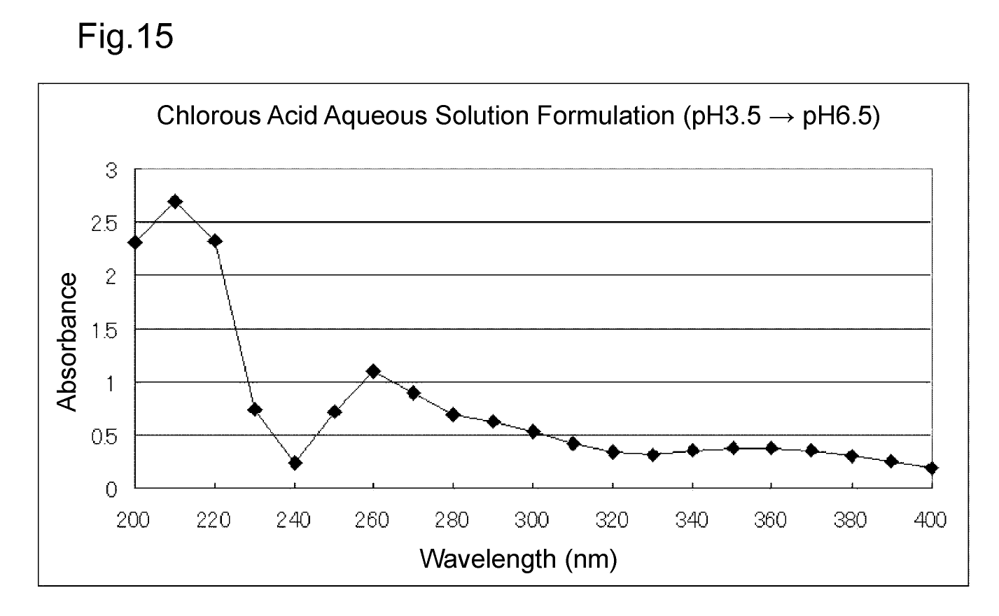

TABLE 4

| | Chlorous acid aqueous solution |
|---|---|
| | formulation manufactured with |
| CAAS Specification | chlorous acid aqueous solution |
| Content | 3.0% |
| Attribute | Yellow |
| Confirmation Test (1) | Match |
| Confirmation Test (2) | Match |
| | (The graph for absorbances and |
| | wavelengths is shown in FIG. 15) |
| Confirmation Test (3) | Match |
| Purity Test (1) | Below detectable limit |
| Purity Test (2) | Below detectable limit |

### Example 2

### Inactivation of Influenza Viruses by Chlorous Acid Aqueous Solution

In the present Example, experiments of inactivating influenza viruses were conducted as an example of virus inactivation by using the “chlorous acid aqueous solution formulation” manufactured with the above-described blend. The methods and results thereof are shown below.

### (Conditions)

PH of a chlorous acid aqueous solution was adjusted to pH 5.5, pH 6.5, pH 7.5 and pH 8.5 by appropriately using potassium hydroxide or sodium hydroxide, or sodium dihydrogen phosphate or potassium dihydrogen phosphate to conduct the experiments of inactivating influenza viruses by a chlorous acid aqueous solution. The influenza viruses that were used were the influenza virus Type A Aichi strain. Further, the titer of the viruses used was 10⁸ cfu. The detailed conditions are shown below.

### (Buffers)

(1) pH 4.5 buffer, (2) pH 5.5 buffer, (3) pH 6.5 buffer, (4) pH 7.5 buffer, (5) pH 8.5 buffer, (6) test solution for untreated control [phosphate buffered saline (Dulbecco's PBS; pH 7.4)]

### 1) Preparation Method of pH 4.5 Buffer

A 0.1 mol/L citric acid aqueous solution was prepared. 90.85 ml of 0.2 mol/L disodium hydrogen phosphate aqueous solution was added to 109.15 ml of the citric acid aqueous solution to adjust the pH to 4.5.

### 2) Preparation Method of pH 5.5 Buffer

A 0.1 mol/L citric acid aqueous solution was prepared. 11.38 ml of 0.2 mol/L disodium hydrogen phosphate aqueous solution was added to 8.63 ml of the citric acid aqueous solution to adjust the pH to 5.5.

### 3) Preparation Method of pH 6.5 Buffer

A 0.1 mol/L citric acid aqueous solution was prepared. 14.20 ml of 0.2 mol/L disodium hydrogen phosphate aqueous solution was added to 5.80 ml of the citric acid aqueous solution to adjust the pH to 6.5.

### 4) Preparation Method of pH 7.5 Buffer

A 0.1 mol/L citric acid aqueous solution was prepared. 18.45 ml of 0.2 mol/L disodium hydrogen phosphate aqueous solution was added to 1.55 ml of the citric acid aqueous solution to adjust the pH to 7.5.
5) Preparation Method of pH 8.5 Buffer

A 0.1 mol/L citric acid aqueous solution was prepared. 20.00 mL of 0.2 mol/L disodium hydrogen phosphate aqueous solution was added to 1.00 mL of the citric acid aqueous solution to adjust the pH to 8.5.

(Storage of Test Sample Solution Etc.)

Each sample solution and buffer was stored at 4° C. (refrigerator) while being wrapped in aluminum foil.

### (Viruses and Cells)

As described above, the influenza virus Type A Aichi strain A/Aichi/68 (H₃N₂) was used as the viruses. MDCK cells (established cells from a canine kidney) were used as cells for culturing and quantifying viruses. Eagle's minimum essential medium (MEM), to which 5% fetal bovine serum was added, was used for culturing the cells. The cells were cultured at 37° C. in the presence of 5% carbon dioxide.

### (Method of Measuring Action of Virucidal Agent)

1) 180 μl of buffer with a designated pH was added to a 2 ml plastic tube (assist tube).
2) 10 μl of chlorous acid aqueous solution with a designated concentration was added.
3) After adding 10 μl of viral solution and sufficiently agitating, the mixture was incubated in a thermostatic water bath at a designated temperature, typically at 25° C. for 30 minutes.
4) Immediately after incubation, the mixture was cooled in ice water and diluted 100-fold with a viral diluent containing proteins.
5) The amount of residual infectious viruses was measured by a plaque assay. The plaque assay is as follows: Viruses treated with various test solutions were diluted to a suitable viral concentration using Dulbecco's phosphate buffered saline (PBS) containing 0.1% bovine serum albumin (BSA). 0.5 ml of said mixture was inoculated into a monolayer culture (5 cm petri dish) of MDCK cells. The viruses were adsorbed while mechanically rocking the viruses on a rocker platform for 60 minutes at room temperature. After unadsorbed viruses were removed by aspiration, plaques were allowed to form on the MDCK cells and the amount of residual infectious viruses was measured. For plaque formation, the MDCK cells after viral adsorption were cultured for two days at 37° C. in a MEM containing 0.8% soft agar and acetylated trypsin (4 μg/ml). After confirming that plaques were produced, the number of plaques was counted by visual observation following simple staining of cells in the petri dish with a 0.5% (w/v) crystal purple stain containing 10% formalin.

### (Virus Inactivation by Sample Solution)

All operations were conducted on ice unless specifically noted otherwise. (1) a chlorous acid aqueous solution, (2) a sodium hypochlorite aqueous solution, (3) a high-grade chlorinated lime formulation aqueous solution, and (4) a sodium chlorite aqueous solution, which were sent by a refrigerated courier service, were stored in a refrigerator while still being wrapped in aluminum foil.

Virus inactivation tests were conducted for each sample solution. Immediately prior to use, a diluted solution was prepared with distilled water so that the chlorine concentration is 10000 ppm. Furthermore, dilution was performed with distilled water to the series of required concentrations in 2.2 ml capacity plastic tubes (assist tubes) with a screw cap. 180 μl of buffer with each pH was dispensed in separately-prepared plastic tubes. After adding 10 μl of diluted sample solution thereto, the mixtures were lightly agitated with a vortex mixer for homogenization.

10 μl of influenza virus solution (10⁸ infectious units) was added thereto and further agitated to prepare a homogenous viral solution to be subjected to testing. After the solution to be subjected to testing was incubated for 30 minutes at 25° C., the solution was immediately cooled in ice water while being diluted 100-fold with cold 0.1% BSA-added PBS to stop the inactivation action. In order to measure the residual virus infectivity titer, the mixture was then appropriately diluted with cold 0.1% BSA-added PBS to quantify the number of infectious viruses in the diluent.

In each of the inactivation experiments, the amount of infectious viruses was measured after being maintained in PBS (phosphate buffered saline) instead of the test sample solution for the same time and at the same temperature. This was deemed the amount of viral load prior to inactivation and the ratio with respect to the amount of residual infectious viruses after inactivation in a test sample solution was calculated.

### (Results)

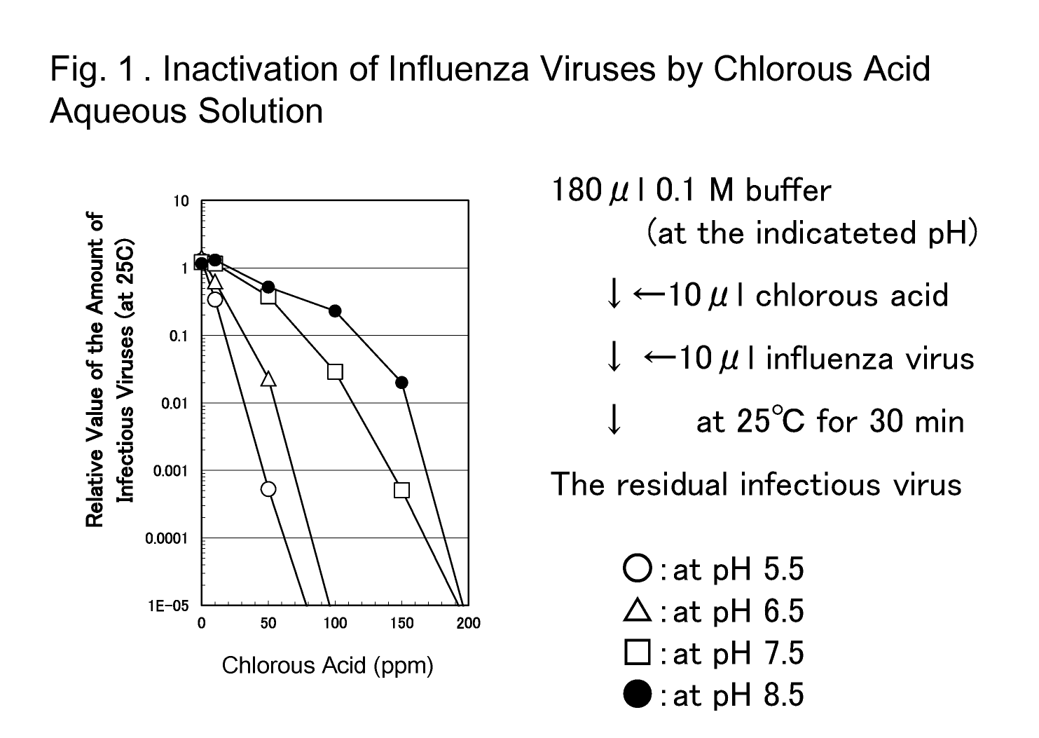

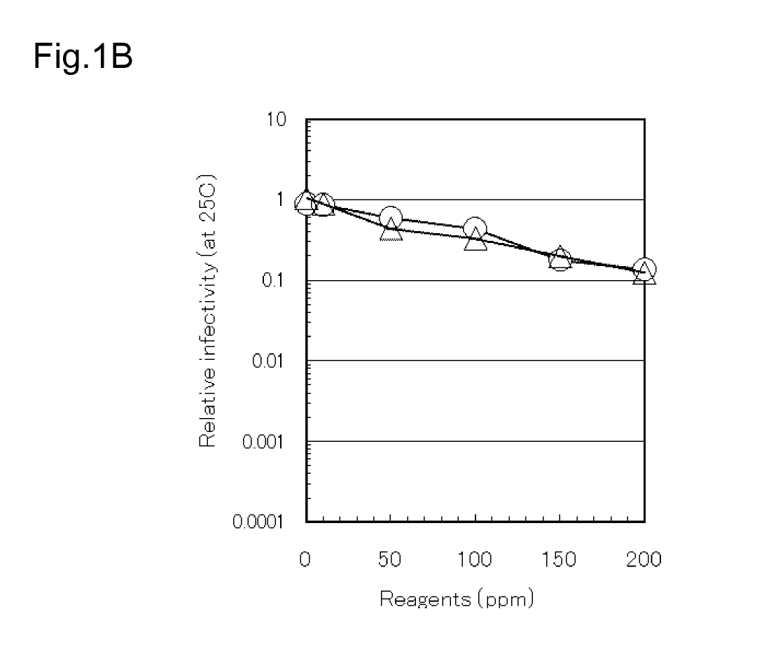

The results are shown in FIG. 1. Among the phosphoric acid buffers used (pH 4.5, pH 5.5, pH 6.5, pH 7.5, and pH 8.5), phosphoric acid buffer alone inactivated influenza viruses to below the detectable limit at pH of 4.5 (data not shown). This is in agreement with a phenomenon known as acid inactivation of influenza viruses. In this regard, the analysis using pH of 4.5 is omitted to show data for pH 5.5, pH 6.5, pH 7.5, and pH 8.5 in FIG. 1. As shown in FIG. 1, inactivation of influenza viruses is significant at lower pH. If pH is 6.5 or lower, infectious viruses decreased to about 1% even at 50 ppm. Further, at a concentration of 200 ppm, it was revealed that there is an effect even at pH of 8.5.

Next, the following Table 4B shows the results of similar experiments using sodium hypochlorite, high-grade chlorinated lime formulation, and sodium chlorite in addition to a chlorous acid aqueous solution as subjects of comparison and using phosphate buffered saline (PBS) as a control.

(Table 4B Inactivation of Influenza Viruses at Each pH at Concentration of 10 ppm)

TABLE 4B

| | | | (3) High-grade | | |
|---|---|---|---|---|---|
| | | (2) Sodium | chlorinated | | |
| | (1) Chlorous acid | hypochlorite aqueous | lime formulation | (4) Sodium chlorite | |
| pH | aqueous solution | solution | aqueous solution | aqueous solution | PBS |
| 8.5 | 1.31 | <0.0002 | 1.70 | 1.07 | 1.00 |
| 7.5 | 1.16 | <0.0002 | 1.10 | 1.09 | 1.00 |
| 6.5 | 0.63 | <0.0002 | 1.50 | 1.19 | 1.00 |
| 5.5 | 0.34 | <0.0002 | 1.35 | 1.07 | 1.00 |
| 4.5 | ND | ND | ND | ND | ND |

Numerical values are ratios of the amount of residual infectious viruses. ND refers to Not Determined.

As is evident from Table 4B, the most potent virus inactivation action was exhibited by the (2) sodium hypochlorite aqueous solution. At each of the pH from pH 5.5 to pH 8.8, viruses were inactivated to below the detectable limit (10⁻⁵) at the concentration of 10 ppm.

The (1) chlorous acid aqueous solution exhibited the next most potent virus inactivation action after the (2) sodium hypochlorite aqueous solution. The action thereof was somewhat pH-dependent. Influenza viruses were inactivated to below the detectable limit at 100 ppm or lower at pH of 5.5 and 6.5. However, virus inactivation action diminished at higher pH values at neutral or alkaline, such as pH of 7.5 and 8.5 (even in this case, viruses were inactivated to about the detectable limit at 200 ppm). Virus inactivation activity was weak and pH-dependent for the (3) high-grade chlorinated lime formulation aqueous solution and (4) sodium chlorite aqueous solution. Inactivation activity could only be detected at pH of 5.5. Even in this case, it was not possible to inactivate viruses to 1/10 at 200 ppm (FIG. 1B).

From the above, it was revealed that the virus disinfectant comprising the chlorous acid aqueous solution of the present invention is a good disinfectant against influenza viruses.

### Example 3

### Inactivation of Herpesviruses by Chlorous Acid Aqueous Solution

In the present Example, experiments of inactivating herpesviruses were conducted as an example of virus inactivation. The methods and results thereof are shown below.

As the method of measuring the action of a virucidal agent, other than changing the viruses to be added and increasing pH to be used to 4.5, 5.5, 6.5, 7.5, and 8.5, the method was performed under the same conditions as those for the method described in Example 2. Herpes simplex virus type I VR-539 was used as the herpesviruses. Further, the titer of the viruses used was 10⁴ cfu. The detailed conditions are shown below.

### (Materials)

### (Test Sample Solution Etc.)

### (Sample Solution)

The following four types of aqueous solutions were used as test solutions:
(1) Chlorous acid aqueous solution;
(2) Sodium hypochlorite aqueous solution;
(3) High-grade chlorinated lime formulation aqueous solution; and
(4) Sodium chlorite aqueous solution.

For each agent, aqueous solutions with five different concentrations, 200 ppm, 150 ppm, 100 ppm, 50 ppm, and 10 ppm, were adjusted with distilled water. Each test solution after dilution was filtered and sterilized using a 0.22 μm filter to examine the effect of pH on sterilizing properties of a chlorous acid aqueous solution.

### (Buffers)

(1) pH 4.5 buffer, (2) pH 5.5 buffer, (3) pH 6.5 buffer, (4) pH 7.5 buffer, (5) pH 8.5 buffer,

### 1) Preparation Method of pH 4.5 Buffer

A 0.1 mol/L citric acid aqueous solution was prepared. 90.85 ml of 0.2 mol/L disodium hydrogen phosphate aqueous solution was added to 109.15 ml of the citric acid aqueous solution to adjust the pH to 4.5.

### 2) Preparation Method of pH 5.5 Buffer

A 0.1 mol/L citric acid aqueous solution was prepared. 11.38 ml of 0.2 mol/L disodium hydrogen phosphate aqueous solution was added to 8.63 ml of the citric acid aqueous solution to adjust the pH to 5.5.

### 3) Preparation Method of pH 6.5 Buffer

A 0.1 mol/L citric acid aqueous solution was prepared. 14.20 ml of 0.2 mol/L disodium hydrogen phosphate aqueous solution was added to 5.80 ml of the citric acid aqueous solution to adjust the pH to 6.5.

### 4) Preparation Method of pH 7.5 Buffer

A 0.1 mol/L citric acid aqueous solution was prepared. 18.45 ml of 0.2 mol/L disodium hydrogen phosphate aqueous solution was added to 1.55 ml of the citric acid aqueous solution to adjust the pH to 7.5.

### 5) Preparation Method of pH 8.5 Buffer

A 0.1 mol/L citric acid aqueous solution was prepared. 20.00 mL of 0.2 mol/L disodium hydrogen phosphate aqueous solution was added to 1.00 mL of the citric acid aqueous solution to adjust the pH to 8.5.

### (Storage of Test Sample Solution Etc.)

Each sample solution and buffer was stored at 4° C. (refrigerator) while being wrapped in aluminum foil.

### (2) Viruses

Herpes simplex virus I VR-539 strain (hereinafter, referred to as HSV-I in some cases) was used as the viruses.

### (Method)

### (Virus Inactivation by Sample Solution)

After inoculating and agitating 1.1-1.8×10⁴ pfu (plaque-forming unit) of HSV-1 in a test solution, the solution was left standing for 30 minutes at 25° C. The entire amount (0.2 ml) of the reaction solution was spread on Vero cells, which were grown to confluence, and gently shaken for one hour at 25° C. to infect the cells with the surviving HSV-I. After further culturing the cells for three days, the number of plaque formations was counted to calculate the number of surviving HSV-I. Further, to correct for effects from pH alone, the number of surviving HSV-I was counted in buffers for pH adjustment (pH 8.5, 7.5, 6.5, 5.5, and 4.5). Then, the ratios of the number of surviving HSV-I after action of each test solution to the number of surviving HSV-1 in the buffers for pH adjustment were compared.

### (Results)

The results are shown in FIG. 2B. As shown in FIG. 2B, plaque counting experiments were conducted by infecting Vero cells with surviving viruses for one hour by using a chlorous acid aqueous solution, as well as sodium hypochlorite, or sodium chlorite that was adjusted with a citric acid/phosphoric acid buffer (0.08 ml) to pH of 8.5, 7.5, 6.5, 5.5, or 4.5. The results are shown in FIG. 2B. A sufficient sterilizing effect was obtained at a concentration of 50 ppm or higher for the chlorous acid aqueous solution. The effect thereof was significant under acidic conditions at pH of 5.5 or lower. It is understood that a sufficient effect can be obtained even at pH of 6.5 or lower when the concentration is 200 ppm or higher. This is in contrast to sodium hypochlorite and sodium chlorite.

Meanwhile, for sodium hypochlorite, a sterilizing effect on herpesvirus type I diminished under acidic conditions of pH 5.5 or lower.

The results of another round of experiments are shown below.

Sterilizing effects of test solutions on HSV-I are shown in Table 4C. The number of surviving HSV-I in a buffer for pH adjustment (pH 8.5, 7.5, 6.5, 5.5, and 4.5) is 85.6-94.4% of the number of inoculated viruses. There was no effect from pH alone on the survival of HSV-I (Table 4D). The (2) sodium hypochlorite aqueous solution exhibited superb action on HSV-I at a concentration of 50 ppm or higher in pH conditions of 6.5-8.5, reducing HSV-I to below the detectable limit. There was no test agent, other than the (2) sodium hypochlorite aqueous solution, which reduced HSV-I to or below 1%, even when used at a concentration of 200 ppm under pH conditions of 6.5-8.5. Meanwhile, agents that reduced HSV-I to below the detectable limit at pH 5.5 are only the (1) chlorous acid aqueous solution and (2) sodium hypochlorite aqueous solution at 150 ppm and 200 ppm. Further, agents that reduced HSV-I to below the detectable limit at pH 4.5 are only the (1) chlorous acid aqueous solution at 100 ppm, 150 ppm and 200 ppm and (4) sodium hypochlorite aqueous solution at 200 ppm. The sterilizing effect of the (2) sodium hypochlorite aqueous solution on HSV-I significantly diminished under acidic conditions (pH 4.5-5.5). However, the (1) chlorous acid aqueous solution at 100 ppm or higher exhibited a superb sterilizing effect on HSV-I under this condition (pH 4.5-5.5). Sterilizing effects of the (1) chlorous acid aqueous solution was examined. The effect was low on HSV-I under alkaline conditions, but a sterilizing effect that was better than the (2) sodium hypochlorite aqueous solution was exhibited under acidic conditions (pH 4.5-5.5). From the above results, a sterilizing effect against a wide range of microorganisms can be expected from the (1) chlorous acid aqueous solution by optimizing usage conditions.

(Table 4C Sterilizing Effect of Test Agents against HSV-I (Determination of Effect by Plaque Assay))

TABLE 4C

| | Number of Residual Viruses in Test Solution/Number | | | | |
|---|---|---|---|---|---|
| | of Residual Viruses only with Buffer × 100 (%) | | | | |
| Test Agent | 200 ppm | 150 ppm | 100 ppm | 50 ppm | 10 ppm |
| pH 8.5 | | | | | |
| (1) Chlorous acid aqueous solution | 30 | 80 | 98.4 | 75.3 | 100 |
| (2) Sodium hypochlorite aqueous solution | <0.4 | <0.2 | <0.3 | <0.3 | 36 |
| (3) High-grade chlorinated lime formulation aqueous | 11.6 | 100 | 100 | 74.4 | 100 |
| solution | | | | | |
| (4) Sodium chlorite aqueous solution | 7.6 | 94 | 78.2 | 91.1 | 100 |
| pH 7.5 | | | | | |
| (1) Chlorous acid aqueous solution | 16.8 | 55.8 | 84.7 | 77.4 | 100 |
| (2) Sodium hypochlorite aqueous solution | <0.4 | <0.2 | <0.3 | <0.3 | 20 |
| (3) High-grade chlorinated lime formulation aqueous | 7.6 | 100 | 100 | 80.2 | 100 |
| solution | | | | | |
| (4) Sodium chlorite aqueous solution | 10.4 | 100 | 100 | 90.4 | 100 |
| pH 6.5 | | | | | |
| (1) Chlorous acid aqueous solution | <0.6 | 22.2 | 76.6 | 63.6 | 100 |
| (2) Sodium hypochlorite aqueous solution | <0.6 | <0.2 | <0.3 | <0.3 | <6 |
| (3) High-grade chlorinated lime formulation aqueous | 15.3 | 100 | 71.8 | 67.8 | 100 |
| solution | | | | | |
| (4) Sodium chlorite aqueous solution | 15.3 | 100 | 87.9 | 83.6 | 100 |
| pH 5.5 | | | | | |
| (1) Chlorous acid aqueous solution | <0.5 | <0.2 | 10.1 | 12.1 | 100 |
| (2) Sodium hypochlorite aqueous solution | <0.5 | <0.2 | 96.4 | 90.9 | 14.3 |
| (3) High-grade chlorinated lime formulation aqueous | 6.7 | 91 | 96.1 | 79.2 | 100 |
| solution | | | | | |
| (4) Sodium chlorite aqueous solution | 8.1 | 100 | 93.2 | 87.3 | 100 |
| pH 4.5 | | | | | |
| (1) Chlorous acid aqueous solution | <0.4 | <0.2 | <0.3 | 1.3 | 48 |
| (2) Sodium hypochlorite aqueous solution | 35.2 | 23.3 | 63.1 | 67.4 | 80 |
| (3) High-grade chlorinated lime formulation aqueous | 0.8 | 37.8 | 30.6 | 40.5 | 72 |
| solution | | | | | |
| (4) Sodium chlorite aqueous solution | <0.4 | 34.4 | 27.6 | 51.5 | 52 |

### (Table 4D Effect of pH on HSV-I (Determination of Effect by Plaque Assay))

TABLE 4D
Number of Residual Viruses only with Buffer/Number
of Inoculated Viruses × 100 (%)

| pH 4.5 | pH 5.5 | pH 6.5 | pH 7.5 | pH 8.5 |
|---|---|---|---|---|
| 92.5 | 87.3 | 85.6 | 94.4 | 93.5 |

### Example 4

### Inactivation of Polioviruses by Chlorous Acid Aqueous Solution (Comparison to Inactivation of Influenza Viruses)

Next, in the present Example, inactivation of polioviruses was verified. In the present Example, a comparison to influenza viruses was conducted. The methods and results thereof are shown below.

As the method of measuring the action of a virucidal agent, the method described in Example 2 was carried out by using influenza viruses or polioviruses and changing pH to 5.5 or 7.5. The influenza virus Type A Aichi strain was used as the viruses. Further, the polioviruses used were poliovirus type I live vaccine strain. Further, the titer of the viruses used was 10⁴ cfu.

### (Results)

The results are shown in FIG. 3. As shown in FIG. 3, polioviruses required higher concentrations of chlorous acid aqueous solution than influenza viruses. The trend of pH is similar to that for influenza viruses. In addition, disinfecting properties were stronger on the acidic side. In any case, it was possible to disinfect most polioviruses at 500 ppm. At 200 ppm, disinfection was only observed at pH of 5.5.

### (Supplementary Study on Polio)

Furthermore, A system of another round of experiments was used to quantitatively analyze inactivation action on polioviruses by a chlorous acid aqueous solution.

### (Materials)

### (1) Test Sample Solution Etc.

### (Sample Solution)

### Chlorous Acid Aqueous Solution (HClO₂)

### (Buffers)

(1) pH 5.5 buffer and (2) pH 7.5 buffer

### 1) Preparation Method of pH 5.5 Buffer

A 0.1 mol/L citric acid aqueous solution was prepared. 11.38 ml of 0.2 mol/L disodium hydrogen phosphate aqueous solution was added to 8.63 ml of the citric acid aqueous solution to adjust the pH to 5.5.

### 2) Preparation Method of pH 7.5 Buffer

A 0.1 mol/L citric acid aqueous solution was prepared. 18.45 ml of 0.2 mol/L disodium hydrogen phosphate aqueous solution was added to 1.55 ml of the citric acid aqueous solution to adjust the pH to 7.5.

### (Storage of Test Sample Solution Etc.)

Each sample solution and buffer was stored at 4° C. (refrigerator) while being wrapped in aluminum foil.

### (2) Viruses and Cells

Poliovirus type 1 (PV1) derived from a vaccine was used as the viruses. Kidney epithelial cells of an African green monkey (Vero cells) were used as cells for culturing and quantifying viruses. In order to confirm a sterilizing effect of a chlorous acid aqueous solution, Eagle's minimum essential medium (MEM) to which 5% fetal bovine serum was added was used to culture the cells. The cells were cultured at 30° C. in the presence of 5% carbon dioxide.

### (Method)

### (1) Method of Quantifying the Number of Infectious Viruses

Quantification was performed by using a plaque assay. Viruses treated with various test solutions were diluted to a suitable viral concentration using Dulbecco's phosphate buffered saline (PBS) containing 0.1% bovine serum albumin (BSA). 0.5 ml of said mixture was inoculated into a monolayer culture (5 cm petri dish) of CRFK cells. The viruses were adsorbed while mechanically rocking the viruses on a rocker platform for 60 minutes at room temperature.

For plaque formation, the Vero cells after viral adsorption were cultured for two days at 30° C. in a MEM containing 0.8% soft agar and acetylated trypsin (5 μg/ml).

After confirming that plaques were produced, the number of plaques was counted by visual observation following simple staining of cells in the petri dish with a 0.5% (w/v) crystal purple stain containing 10% formalin.

### (2) Method of Confirming Inactivation Effect on Viruses by Test Solution

All operations were conducted on ice unless specifically noted otherwise. Each sample solution was stored in a refrigerator while being wrapped in aluminum foil.

Virus inactivation tests were conducted for each sample solution. Immediately prior to use, (i) a chlorous acid aqueous solution was diluted according to an instruction with distilled water so that the chlorous acid concentration is 10000 ppm. Furthermore, 10 μl thereof was then added to 180 μl of phosphoric acid buffer at each pH, and the mixtures were lightly agitated with a vortex mixer for homogenization. 10 μl of poliovirus solution (about 10⁷ infectious units) was added thereto and further agitated to prepare a homogeneous viral solution to be subjected to testing.

After the solution to be subjected to testing was incubated for 30 minutes at 25° C., the solution was immediately cooled in ice water while being diluted 100-fold with cold 0.1% BSA-added PBS for neutralization treatment. In order to measure the residual virus infectivity titer, the mixture was then appropriately diluted with cold 0.1% BSA-added PBS to quantify the number of infectious viruses therein.

### (Results)

The results are shown in FIG. 3B. When quantitative analysis of inactivation action on polioviruses by a chlorous acid aqueous solution was examined, since a significant virus disinfection effect was observed even at 50 ppm on influenza viruses represented by white circles (pH 7.5), the quantity could not be confirmed. However, other than the influenza viruses represented by white circles, the quantity was confirmed for polioviruses (black circles pH 5.5, black triangles pH 7.5), as was the case for the influenza viruses represented by white triangles (pH 5.5).

### Example 5

### Measurement of Rates of Inactivation of Influenza Viruses by Chlorous Acid Aqueous Solution

Next, rates of inactivation of influenza viruses by a chlorous acid aqueous solution were measured in the present Example. The methods and results are shown below.

As a method of measuring the action of a virucidal agent, the method described in Example 2 was used with pH at 6.5. In addition, a chlorous acid aqueous solution at 100 ppm was used, and the concentration of chlorous acid upon contact with influenza viruses was 5 ppm. Samples after 0, 0.5, 1, and 4 minutes were collected to see whether the viruses were inactivated.

### (Results)

The results are shown in FIG. 4. As shown in FIG. 4, it can be seen that the disinfecting of the chlorous acid aqueous solution on influenza viruses was almost completed after 30 seconds had past.

### Examples 6 Comparison Between Cytotoxic Action of Chlorous Acid Aqueous Solution and that of Sodium Hypochlorite (1)

In the present Example, experiments were conducted using HEp-2 cells in order to compare cytotoxic action of a chlorous acid aqueous solution with that of sodium hypochlorite. The methods and results thereof are shown.

HEp-2 cells were prepared in a monolayer culture, washed four times with saline, and incubated for 20 minutes at freezing temperature in a balanced salt solution comprising reagents at various concentrations (e.g., pH 5.5). The reagents were removed from the treated cells, which were stored for 60 minutes at 37° C. in a culture solution. The cells were stripped off by using trypsin, and dyes were eliminated with trypan blue by using a cell suspension. The number of live cells and the number of dead cells were calculated by counting.

### (Results)

The results are shown in FIG. 5. As shown in FIG. 5, when cytotoxic action of a chlorous acid aqueous solution is compared to that of sodium hypochlorite, sodium hypochlorite generated dead cells even at about 0.5 ppm, whereas for the chlorous acid aqueous solution of the present invention, dead cells were confirmed at 50 ppm only at an amount similar to those generated by sodium hypochlorite at 0.5 ppm, thus there was practically no effect. From the above, a chlorous acid aqueous solution is understood as capable of providing a safe antiseptic virus disinfectant due to safety (low toxicity) to cells.

### Example 7

### Comparison Between Cytotoxic Action of Chlorous Acid Aqueous Solution and that of Sodium Hypochlorite (2)

Next, in the present Example, cytotoxic action of a chlorous acid aqueous solution was compared to that of sodium hypochlorite to confirm cytotoxicity when a variety of pH is used. The methods and results thereof are shown.

HEp-2 cells were prepared in a monolayer culture, washed four times with saline, and incubated for 20 minutes at freezing temperature in a balanced salt solution comprising buffers of various pH and reagents at various concentrations. The reagents were removed from the treated cells, which were stored for 60 minutes at 37° C. in a culture solution. The cells were stripped off by using trypsin, and dyes were excluded with trypan blue by using a cell suspension. The number of live cells and the number of dead cells were calculated by counting.

### (Results)

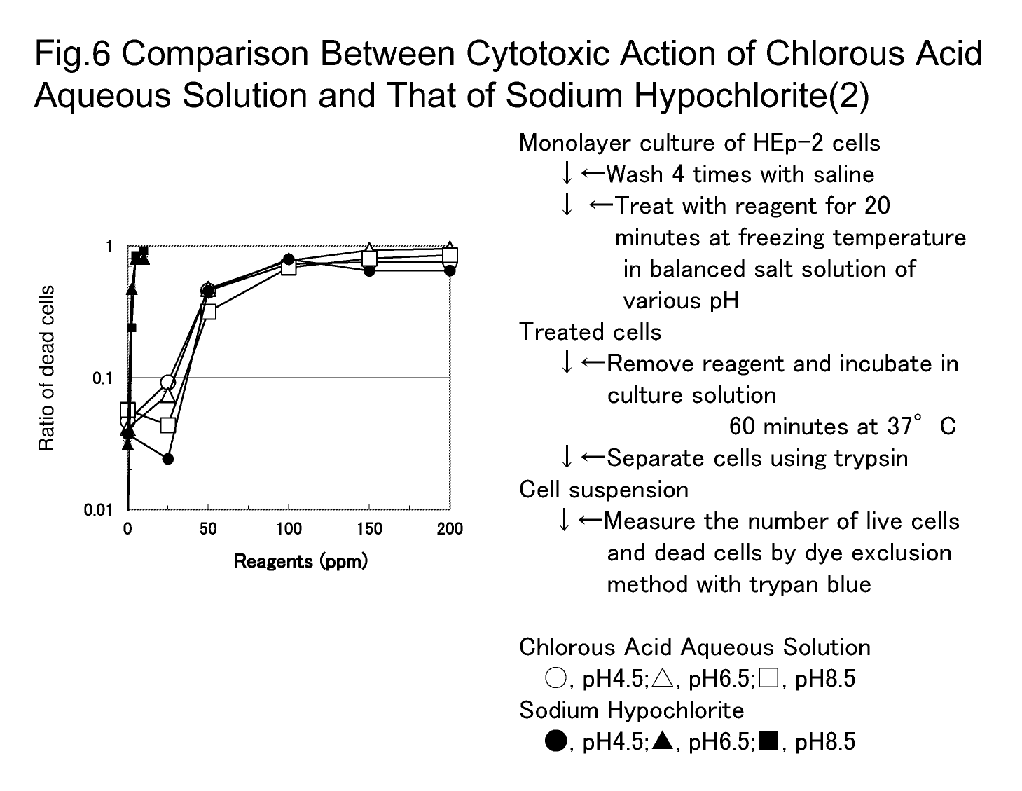

The results are shown in FIG. 6. As shown in FIG. 6, not much difference was observed due to pH. However, although cells were annihilated with a minute concentration of sodium hypochlorite, similar ratio of dead cells was achieved at 100 ppm or higher for the chlorous acid aqueous solution. Thus, there was a 100-fold difference in cytotoxic action.

### Examples 8 Comparison Between Cytotoxic Action of Chlorous Acid Aqueous Solution and that of Sodium Hypochlorite (3)

Next, in the present Example, impairment in colony formation capability of each of Vero cells (purchased from American Type Culture Collection (ATCC)), HEp-2 cells (from the University of Tokushima, Faculty of Medicine, Virology Class) and MDCK cells (from the University of Tokushima, Faculty of Medicine, Virology Class) was examined.

The method follows that of Example 6. However, the cells that were used were changed to Vero, HEp-2, and MDCK and phosphate buffer was used as the buffer in an aqueous solution.

Each buffer was made as follows.

(Method of Making Phosphoric Acid Buffer)

<<Reagents that were Used>>
Citric acid (QINDAO FUSO REFINING & PROCESSING CO. LTD.) Disodium hydrogen phosphate (RIN KAGAKU KOGYO CO., LTD.)

### <<Preparation Methods>>

pH 3.5 buffer 6.07 mL of 0.2 mol/L disodium hydrogen phosphate aqueous solution was added to 13.93 mL of 0.1 mol/L citric acid aqueous solution.
pH 4.0 buffer 7.71 mL of 0.2 mol/L disodium hydrogen phosphate aqueous solution was added to 12.29 mL of 0.1 mol/L citric acid aqueous solution.
pH 4.5 buffer 9.09 mL of 0.2 mol/L disodium hydrogen phosphate aqueous solution was added to 10.92 mL of 0.1 mol/L citric acid aqueous solution.
pH 5.0 buffer 10.30 mL of 0.2 mol/L disodium hydrogen phosphate aqueous solution was added to 9.70 mL of 0.1 mol/L citric acid aqueous solution.
pH 5.5 buffer 11.38 mL of 0.2 mol/L disodium hydrogen phosphate aqueous solution was added to 8.63 mL of 0.1 mol/L citric acid aqueous solution.
pH 6.0 buffer 12.63 mL of 0.2 mol/L disodium hydrogen phosphate aqueous solution was added to 7.33 mL of 0.1 mol/L citric acid aqueous solution.
pH 6.5 buffer 14.20 mL of 0.2 mol/L disodium hydrogen phosphate aqueous solution was added to 5.80 mL of 0.1 mol/L citric acid aqueous solution.
pH 7.0 buffer 16.47 mL of 0.2 mol/L disodium hydrogen phosphate aqueous solution was added to 3.53 mL of 0.1 mol/L citric acid aqueous solution.
pH 7.5 buffer 18.45 mL of 0.2 mol/L disodium hydrogen phosphate aqueous solution was added to 1.55 mL of 0.1 mol/L citric acid aqueous solution.

### (Method of Making Good's Acid Buffer)

<<Reagents that were Used>>
NaCl (Wako 191-01665)
KCl (Wako 163-03545)
MES [2-morpholinoethanesulfonic acid] (Wako 349-01623)
HEPES [2-[4-(2-hydroxyethyl)-1-piperazinyl]ethanesulfonic acid] (Wako 346-01373)
TAPS [N-tris-hydroxymethyl-3-aminopropanesulfonic acid] (Wako 344-02572)
1N NaOH
1N HCl

### <<Preparation Method>>

Undiluted Saline Solution After 10.24 g of NaCl and 0.25 g of KCl were dissolved in about 600 ml of distilled water, distilled water was added so that the mixture was 1000 mL.
pH 5.5 buffer 4265 mg of MES was dissolved in 800 ml of undiluted saline solution. 1N NaOH or 1N HCl was titrated therein while checking a pH meter. After adjusting to pH 5.5, distilled water was added so that the mixture was 1000 ml.
pH 6.5 buffer 4265 mg of MES was dissolved in 800 ml of undiluted saline solution. 1N NaOH or 1N HCl was titrated therein while checking a pH meter. After adjusting to pH 6.5, distilled water was added so that the mixture was 1000 ml.
pH 7.5 buffer 4765 mg of HEPES was dissolved in 800 ml of undiluted saline solution. 1N NaOH or 1N HCl was titrated therein while checking a pH meter. After adjusting to pH 7.5, distilled water was added so that the mixture was 1000 ml.
pH 8.5 buffer 4865 mg of TAPS was dissolved in 800 ml of undiluted saline solution. 1N NaOH or 1N HCl was titrated therein while checking a pH meter. After adjusting to pH 8.5, distilled water was added so that the mixture was 1000 ml.

### (Results)

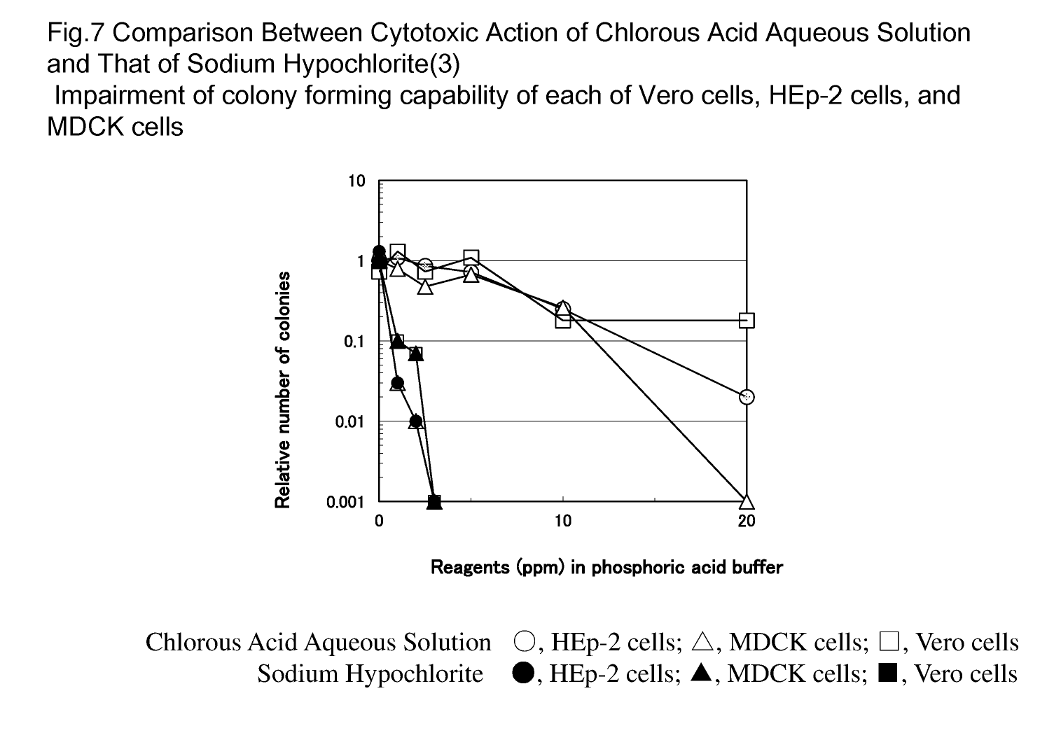

The results are shown in FIG. 7. As shown in FIG. 7, for sodium hypochlorite, impairment in colony formation of each cell was observed at 5 ppm or lower. However, for a chlorous acid aqueous solution, impairment in colony formation of Hep-2 cells and Vero cells was not observed even at 20 ppm. However, although impairment in colony formation was confirmed for MDCK cells, impairment action in comparison to that of sodium hypochlorite was about ¼.

### Example 9

### Confirmation of Inactivation Effect on Feline Caliciviruses for Confirmation of Effect on Noroviruses (1)

In the present Example, an inactivation effect was confirmed by use of feline caliciviruses, which is recognized in the field as a substitute experiment for confirming an effect on noroviruses. For noroviruses, please refer to Norovirus Fukatsuka Yukosei Hyoka Shiken ni okeru Daikan Virus, Nekokarisi Virus Shiyo ni yoru Shikenho [Testing method using a substitute virus, feline calicivirus, in inactivation effectiveness assessment test on norovirus], EPA and 2007 Norovirus no Fukatsuka Jokenni Kansuru Chosa Hokokusho [Investigative Report on Inactivation Conditions of Norovirus], National Institute of Health Sciences, Division of Biomedical FoodResearch, Shigeki YAMAMOTO and Mamoru NODA, Japanese Ministry of Health, Labour and Welfare. In addition to these documents, please refer to the following references with regard to an examination of virus disinfecting effect on noroviruses being replaceable with an examination using related bacteria, feline calicivirus (FCV): Gehrke, C et al: Inactivation of feline calicivirus, a surrogate of norovirus (formerly Norwalk-like viruses), by different types of alcohol in vitro and in vivo, J Hosp Infect (2004) 46:49-55; Doultree, J C et al: Inactivation of feline calicivirus, a norwalk virus surrogate, J Hosp Infect (1999) 41:51-57); Jennifer, L et al: Surrogates for the study of norovirus stability and inactivation in the environment: A comparison of murine norovirus and feline calicivirus, J Food Protect (2006) 11:2761-2765; Hirotaka TAKAGI et al: Neko Calicivirus (FCV) wo Daikan to shita Norovirus (NV) Fukatsuka Koka no Kento-Arukarizai, Kasankasuiso, and Katansan Natoriumu ni yoru Fukasseika Koka-[Investigation on Norovirus (NV) Inactivation Effect with Feline Calicivirus (FCV) as a Substitute-Inactivation Effect by Alkaline Agent, Hydrogen Peroxide, and Sodium Percarbonate], Japanese Journal of Medicine and Pharmaceutical Science (2007) 57:311-312) (These references are incorporated herein by reference). The methods and results are shown below.

### (Materials)

As reagents to be used, the “chlorous acid aqueous solution” prepared in Example 1, 10 w/w % potassium iodide, 10% sulfuric acid, and 0.1 M sodium thiosulfate were used.

### (Viruses and Cells)

The feline calicivirus F4 strain was used as the viruses and CRFK cells were used as cells for culturing and quantifying the viruses (obtained from National Institute of Infectious Diseases, Department of Virology II).

For cell culturing, Eagle's minimum essential medium (MEM) to which 5% fetal bovine serum was added was used. The cells were cultured at 37° C. in the presence of 5% carbon dioxide. Cells that formed a monolayer culture layer on a petri dish were used.

### (Methods)

### (1 Quantification of Number of Infectious Viruses)

Quantification was performed by using a plaque assay. Viruses treated with various test solutions were diluted to a suitable viral concentration using Dulbecco's phosphate buffered saline (PBS) containing 0.5% FBS. 0.5 ml of said mixture was inoculated into a monolayer culture (5 cm petri dish) of CRFK cells. The viruses were adsorbed while mechanically rocking the viruses on a rocker platform for 60 minutes at room temperature.

For plaque formation, the CRFK cells after viral adsorption were cultured over night at 37° C. in a MEM containing 0.68% methyl cellulose and 0.5% FBS. After confirming that plaques were produced, the number of plaques was counted by visual observation following simple staining of cells in the petri dish with a 0.5% (w/v) crystal purple stain containing 10% formalin.

### (2 Virus Inactivation)

Each sample solution was stored in a refrigerator while being wrapped in aluminum foil. All operations were conducted on ice unless specifically noted otherwise. Virus inactivation tests for “chlorous acid aqueous solution” were conducted by preparation with distilled water to dilute to a series of required concentrations [chlorous acid (HClO₂) concentrations 7200 ppm, 1200 ppm, 400 ppm, 200 ppm, and 100 ppm] in 2.2 ml capacity plastic tubes (assist tubes) with a screw cap. The mixtures were then lightly agitated with a vortex mixer for homogenization. 10 μl of feline calicivirus solution (about 10⁷ infectious units) was added thereto so that the total amount is 180 μl and further agitated to prepare a homogenous viral solution to be subjected to testing. After maintaining moisture for 5 minutes at 25° C. for the solution to be subjected to testing, the solution was immediately cooled in ice water while appropriately being diluted by adding cooled 0.5% FBS to PBS to quantify the number of infectious viruses.

In the inactivation experiments, the amount of infectious viruses after being maintained in PBS (phosphate buffered saline) instead of the test sample solutions for the same time and at the same temperature was measured. This was deemed the amount of viral load prior to inactivation and ratios with respect to the amount of residual infectious viruses after inactivation in the test sample solutions were calculated.

### (Results)

The results of confirming inactivation effects on viruses are shown in the following Table 5.

### (Table 5 Inactivation of Viruses at Each Chlorous Acid Concentration)

TABLE 5

| Chlorous Acid Concentration (ppm) | Feline Calciviruses | PBS^{} |
|---|---|---|
| 7,200 | N.D. | 1.00 |
| 1,200 | N.D. | 1.00 |
| 400 | N.D. | 1.00 |
| 200 | 0.38 | 1.00 |
| 100 | 0.66 | 1.00 |

In the Table, “N.D.” refers to below the detectable limit, thus confirming a complete inactivation effect.
Chlorous acid concentration: Chlorous acid concentration (ppm) in a diluent of a chlorous acid aqueous solution
The numerical values are ratios of the amount of residual infectious viruses.
*With the result of measuring the amount of infectious viruses after being maintained in PBS (phosphate buffered saline) instead of the test sample solution for the same time and at the same temperature as “1.00”, ratios with respect to the amount of residual infectious viruses after inactivation in the test sample solution were calculated.

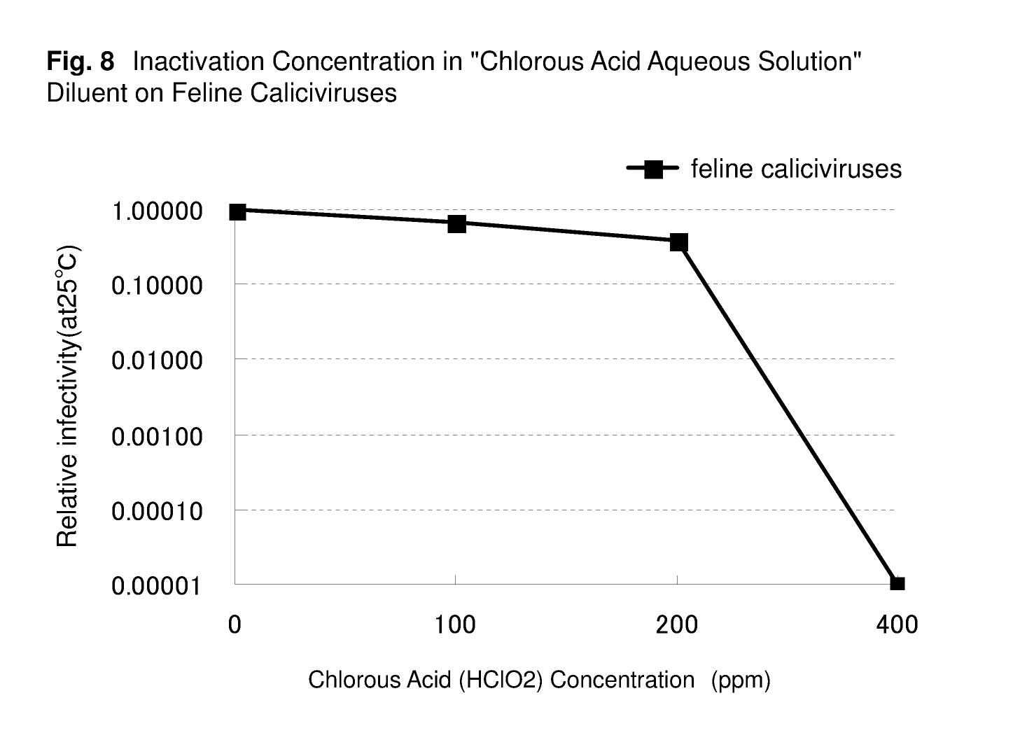

Further, FIG. 8 shows the plotted results thereof. As shown in FIG. 8, it was demonstrated that there is a disinfecting capability at 400 ppm against feline caliciviruses. That is, an inactivation effect can be expected at 400 ppm against feline caliciviruses that have the same activation mechanism as noroviruses. In addition, it is possible to confirm from FIG. 3 that polioviruses having the same structure as noroviruses are sufficiently inactivated at 500 ppm. Thus, it is possible to expect a sufficient inactivation effect on noroviruses at a concentration of 400 ppm to 500 ppm.

### Example 10

### Confirmation of Inactivation Effect on Feline Caliciviruses for Confirmation of Effect on Noroviruses (2)

In the present Example, effects on noroviruses were examined in continuation of the above-described Example, with feline caliciviruses as the barometer stock.

### (Materials)

### (Test Sample Solution Etc.)

### (Sample Solutions)

(1) Chlorous acid aqueous solution (HClO₂)
(2) Chlorous acid aqueous solution formulation manufactured in Example 1
(3) Sodium hypochlorite aqueous solution (Nankai Chemical Co., Ltd.)

### (Buffers)

(1) pH 4.5 buffer, (2) pH 5.5 buffer, (3) pH 6.5 buffer, (4) pH 7.5 buffer, (5) pH 8.5 buffer, and (6) test solution for untreated control [phosphate buffered saline (Dulbecco's PBS; pH 7.4)]

### 1) Preparation Method of pH 4.5 Buffer

A 0.1 mol/L citric acid aqueous solution was prepared. 90.85 ml of 0.2 mol/L disodium hydrogen phosphate aqueous solution was added to 109.15 ml of the citric acid aqueous solution to adjust the pH to 4.5.

### 2) Preparation Method of pH 5.5 Buffer

A 0.1 mol/L citric acid aqueous solution was prepared. 11.38 ml of 0.2 mol/L disodium hydrogen phosphate aqueous solution was added to 8.63 ml of the citric acid aqueous solution to adjust the pH to 5.5.

### 3) Preparation Method of pH 6.5 Buffer

A 0.1 mol/L citric acid aqueous solution was prepared. 14.20 ml of 0.2 mol/L disodium hydrogen phosphate aqueous solution was added to 5.80 ml of the citric acid aqueous solution to adjust the pH to 6.5.

### 4) Preparation Method of pH 7.5 Buffer

A 0.1 mol/L citric acid aqueous solution was prepared. 18.45 ml of 0.2 mol/L disodium hydrogen phosphate aqueous solution was added to 1.55 ml of the citric acid aqueous solution to adjust the pH to 7.5.

### 5) Preparation Method of pH 8.5 Buffer

A 0.1 mol/L citric acid aqueous solution was prepared. 20.00 ml of 0.2 mol/L disodium hydrogen phosphate aqueous solution was added to 1.00 ml of the citric acid aqueous solution to adjust the pH to 8.5.

### (Storage of Test Sample Solution Etc.)

Each sample solution and buffer was stored at 4° C. (refrigerator) while being wrapped in aluminum foil.

### (2) Viruses and Cells

The feline calicivirus F4 strain from the National Institute of Infectious Diseases was used as the viruses. CRFK cells from the National Institute of Infectious Diseases were used as cells for culturing and quantifying viruses. Eagle's minimum essential medium (MEM) to which 5% fetal bovine serum (FBS) was added was used for culturing the cells. The cells were cultured for three days at 37° C. in the presence of 5% carbon dioxide. Cells that formed a monolayer culture layer on a petri dish were used.

### (Method)

### (1) Quantification of the Number of Infectious Viruses

Quantification was performed by using a plaque assay. Viruses treated with various test solutions were diluted to a suitable viral concentration using Dulbecco's phosphate buffered saline (PBS) containing 0.5% FBS. 0.5 ml of said mixture was inoculated into a monolayer culture (5 cm petri dish) of CRFK cells. The viruses were adsorbed while mechanically rocking the viruses on a rocker platform for 60 minutes at room temperature.

For plaque formation, the CRFK cells after viral adsorption were cultured over night at 37° C. in a MEM containing 0.68% methyl cellulose and 0.5% FBS. After confirming that plaques were produced, the number of plaques was counted by visual observation following simple staining of cells in the petri dish with a 0.5% (w/v) crystal purple stain containing 10% formalin.

### (2) Virus Inactivation by Sample Solution

Each sample solution was stored in a refrigerator while being wrapped in aluminum foil. All operations were conducted on ice unless specifically noted otherwise. Virus inactivation tests were conducted for each sample solution. Immediately prior to use, (i) a chlorous acid aqueous solution and (ii) a sodium hypochlorite aqueous solution were diluted with distilled water so that the chlorine concentration is 10000 ppm. The diluted solutions were further diluted with distilled water to the required concentrations in assist tubes. After 10 μl thereof was added to 180 μl of phosphoric acid buffer with each pH, the mixtures were lightly agitated with a vortex mixer for homogenization. Further, for the chlorous acid aqueous solution formation manufactured in the Examples of the present invention, after preparing said formulation with distilled water so that the final concentration is diluted 6-fold, 12-fold or more, the mixtures were lightly agitated with a vortex mixer for homogenization. 10 μl of feline calicivirus solution (about 10⁷ infectious units/ml) was added thereto and further agitated to prepare a homogenous virus solution to be subjected to testing. After the solution to be subjected to testing was incubated at 25° C. for a certain period of time, the solution was immediately cooled in ice water while being diluted 100-fold with cold 0.5% FBS-added PBS to stop the inactivation action. In order to measure the residual virus infectivity titer, the mixture was then appropriately diluted with cold 0.5% FBS added PBS to quantify the number of infectious viruses therein.

### (Results)

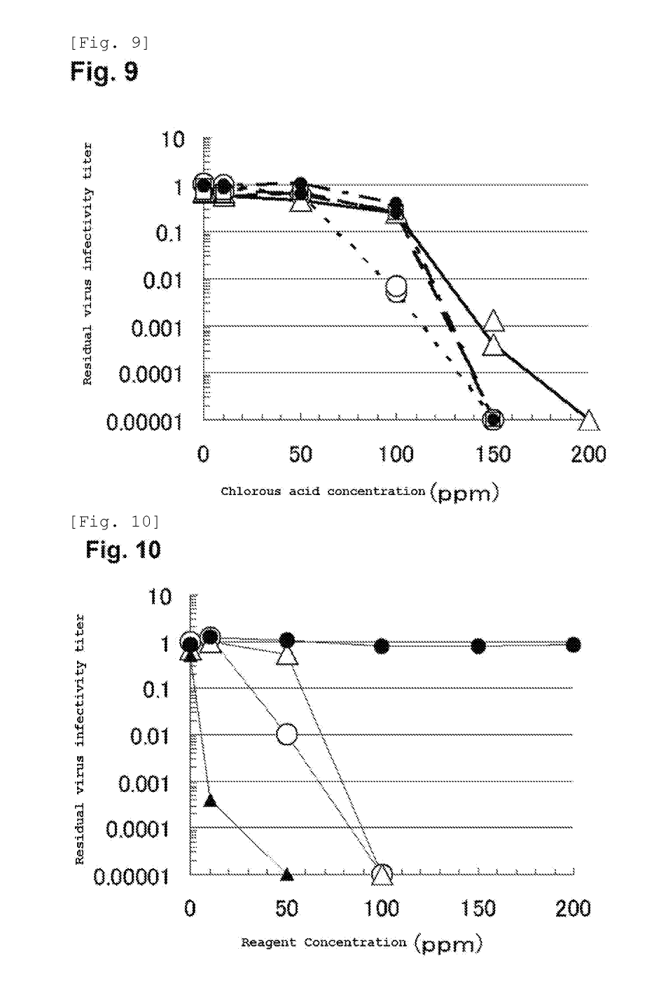

The results are shown in FIGS. 9-12.

### (1) Inactivation Action on Feline Caliciviruses by Chlorous Acid Aqueous Solution

Examinations were conducted on inactivation against feline caliciviruses by (i) a chlorous acid aqueous solution with various concentrations when treated with 0.1 M citric acid/sodium phosphate buffer of four different pH (pH 5.5, pH 6.5, pH 7.5, pH 8.5) for 30 minutes at 25° C. As a result, the feline caliciviruses were inactivated by the (i) chlorous acid aqueous solution. Inactivation was more significant when pH of the buffer was acidic. However, the feline caliciviruses were inactivated to below the detectable limit at each pH that was examined at active chlorine concentrations of 200 ppm or higher (FIG. 9).

### (2) Inactivation Action on Viruses by Chlorous Acid Aqueous Solution Formulation

A chlorous acid aqueous solution formulation inactivated influenza viruses or feline caliciviruses while being incubating at 25° C. for five minutes. The amount of infectious viruses decreased to below 0.005% (detectable limit at this time) for each virus, even at 36-fold dilution.

Comparison of Inactivation Activity on Feline Caliciviruses between (i) Chlorous Acid Aqueous Solution and (iii) Sodium Hypochlorite

Examinations were conducted on inactivation of feline caliciviruses by (i) a chlorous acid aqueous solution and (iii) sodium hypochlorite at various concentrations when treated with 0.1 M citric acid/sodium phosphate buffer at two different pH (pH 4.5 and pH 7.5) for 30 minutes at 25° C.

As a result thereof, the (i) chlorous acid aqueous solution inactivated the feline caliciviruses with hardly any effect due to pH. However, the (iii) sodium hypochlorite was greatly affected by pH. At pH of 4.5, feline caliciviruses inactivation capability was lost. At neutral pH, inactivation action of the (iii) sodium hypochlorite was stronger than the (i) chlorous acid aqueous solution (FIG. 10).

### (3) Virus Inactivation by Chlorous Acid Aqueous Solution Formulation in 10% Miso

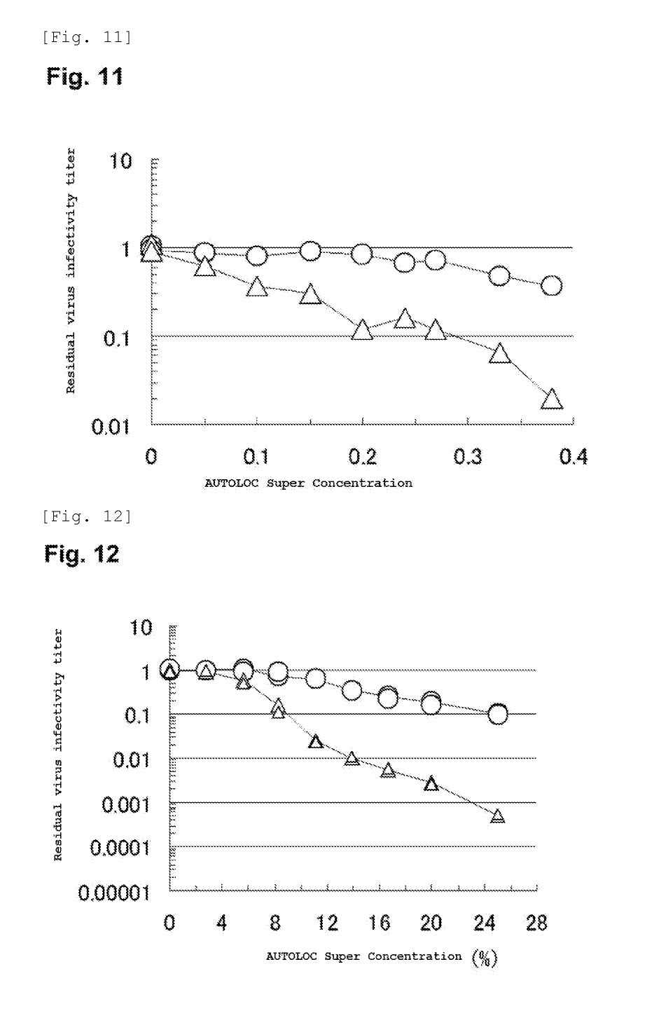

A chlorous acid aqueous solution formulation inactivated feline caliciviruses or Type A influenza viruses that were uniformly mixed into 10% miso/PBS solution with incubation at 25° C. for five minutes. Although the influenza viruses were more significantly inactivated than the feline caliciviruses, the level of inactivation was not very strong. 10% of infectious viruses of the influenza viruses remained even with a 4-fold diluent (FIG. 11).

### (4) Virus Inactivation by (ii) Chlorous Acid Aqueous Solution Formulation in 10% Miso

A (ii) chlorous acid aqueous solution formulation inactivated feline caliciviruses that were uniformly mixed into 10% miso/PBS solution. Although the formulation exhibited inactivation action with incubation at 25° C. for five minutes, a very strong inactivation was exhibited when time of incubation was extended to 20 minutes. Even with a 4-fold diluent, the amount of infectious viruses was reduced to 1/1000 or less. The fact that feline caliciviruses mixed into 10% miso/PBS solution can be inactivated demonstrates that a (ii) chlorous acid aqueous solution formulation can inactivate viruses in the presence of a large amount of organic matters. In addition, the fact that the inactivation effect was enhanced by extending treatment time demonstrates that active chlorine molecules in a (ii) chlorous acid aqueous solution formulation would not be dissipated at once (FIG. 12).

### Example 11

### Confirmation of Inactivation Effect on Feline Caliciviruses for Confirmation of Effect on Noroviruses (3)

In the present Example, inactivation effects on feline caliciviruses were examined in another example in order to examine the effect on noroviruses.

### (Materials)

### (1) Test Sample Solution Etc.

### (Test Solutions)

(i) Chlorous acid aqueous solution (HClO₂)
(ii) Chlorous acid aqueous solution formulation (AUTOLOC Super)
(iii) Sodium hypochlorite aqueous solution (Nankai Chemical Co., Ltd.)

### (Buffers)

(i) pH 4.5 buffer, (ii) pH 5.5 buffer, (iii) pH 6.5 buffer, (iv) pH 7.5 buffer, (v) pH 8.5 buffer

### (i) Preparation Method of pH 4.5 Buffer

A 0.1 mol/L citric acid aqueous solution was prepared. 90.85 ml of 0.2 mol/L disodium hydrogen phosphate aqueous solution was added to 109.15 ml of the citric acid aqueous solution to adjust the pH to 4.5.

### (ii) Preparation Method of pH 5.5 Buffer

A 0.1 mol/L citric acid aqueous solution was prepared. 11.38 ml of 0.2 mol/L disodium hydrogen phosphate aqueous solution was added to 8.63 ml of the citric acid aqueous solution to adjust the pH to 5.5.

(iii) Preparation Method of pH 6.5 Buffer

A 0.1 mol/L citric acid aqueous solution was prepared. 14.20 ml of 0.2 mol/L disodium hydrogen phosphate aqueous solution was added to 5.80 ml of the citric acid aqueous solution to adjust the pH to 6.5.

### (iv) Preparation Method of pH 7.5 Buffer

A 0.1 mol/L citric acid aqueous solution was prepared. 18.45 ml of 0.2 mol/L disodium hydrogen phosphate aqueous solution was added to 1.55 ml of the citric acid aqueous solution to adjust the pH to 7.5.

### (v) Preparation Method of pH 8.5 Buffer

A 0.1 mol/L citric acid aqueous solution was prepared. 20.00 ml of 0.2 mol/L disodium hydrogen phosphate aqueous solution was added to 1.00 ml of the citric acid aqueous solution to adjust the pH to 8.5.

### (Storage of Test Sample Solution Etc.)

Each sample solution and buffer was stored at 4° C. (refrigerator) while being wrapped in aluminum foil.

### (2) Viruses and Cells

The feline calicivirus F4 strain from the National Institute of Infectious Diseases was used as the viruses. CRFK cells from the National Institute of Infectious Diseases were used as cells for culturing and quantifying the viruses.

Eagle's minimum essential medium (MEM) to which 5% fetal bovine serum (FBS) was added was used for culturing the cells. The cells were cultured for three days at 37° C. in the presence of 5% carbon dioxide. Cells that formed a monolayer culture layer on a petri dish were used.

### (Method)

### (1) Method of Quantifying the Number of Infectious Viruses

Quantification was performed by using a plaque assay. Viruses treated with various test solutions were diluted to a suitable viral concentration using Dulbecco's phosphate buffered saline (PBS) containing 0.1% bovine serum albumin (BSA). 0.5 ml of said mixture was inoculated into a monolayer culture (5 cm petri dish) of CRFK cells. The viruses were adsorbed while mechanically rocking the viruses on a rocker platform for 60 minutes at room temperature.

For plaque formation, the CRFK cells after viral adsorption were cultured for two days at 37° C. in a MEM containing 0.8% soft agar and acetylated trypsin (5 μg/ml).

After confirming that plaques were produced, the number of plaques was counted by visual observation following simple staining of cells in the petri dish with a 0.5% (w/v) crystal purple stain containing 10% formalin.

### (2) Method of Confirming Virus Inactivation Effect by Sample Solution

All operations were conducted on ice unless specifically noted otherwise. Each sample solution was stored in a refrigerator while being wrapped in aluminum foil.

Virus inactivation tests were conducted for each sample solution. A (1) chlorous acid aqueous solution and a (iii) sodium hypochlorite aqueous solution were diluted in accordance with an instruction so that the chlorous acid concentration of the (1) chlorous acid aqueous solution and available chlorine concentration of the (iii) sodium hypochlorite aqueous solution diluted with distilled water immediately prior to use were 10000 ppm. The diluted solutions were used and further diluted with distilled water to the required concentrations in assist tubes. After 10 μl of diluted sample solution was added to 180 μl of phosphoric acid buffer at each pH, the mixtures were lightly agitated with a vortex mixer for homogenization.

Further, for (ii) chlorous acid aqueous solution formation (AUTOLOC Super), after adjusting the formulation so that the final concentration was diluted 6-fold, 12-fold or more, the mixtures were lightly agitated with a vortex mixer for homogenization.

10 μl of feline calicivirus solution (10⁷ infectious units) was added thereto and further agitated to prepare a homogenous viral solution to be subjected to testing.

After incubating the solution to be subjected to testing at 25° C. for 30 minutes, the solution was immediately cooled in ice water while being diluted 100-fold with cold 0.1% BSA-added PBS for neutralization treatment. In order to measure the residual virus infectivity titer, the mixture was then appropriately diluted with cold 0.1% BSA-added PBS to quantify the number of infectious viruses.

### (Results)

The present Example is different from the above-described Examples in that the following reagents, instrument and testing method were changed to culture CRFK cells and feline caliciviruses and to perform a plaque assay.

### <Reagents/Instrument>

TABLE 6

| | | |
|---|---|---|
| Item | Example 10 | Example 11 |

<Cell Culture>

| | | |
|---|---|---|
| Cell | Eagle's minimum | Gibco MEM (×1) medium, |
| culture | essential medium | to which FBS (adjusted |
| medium | (MEM), to which | so that the final |
| | bicarbonate, glutamine, | concentration is 5%), |
| | and FBS (adjusted so | was used. |
| | that the final | |
| | concentration is | |
| | 5%) were added, was | |
| | used. | |
| Trypsin | 0.05% trypsin solution | 0.025% trypsin solution |
| solution | was used. | was used. (Since CRFK |
| | | cells are highly |
| | | sensitive to trypsin, |
| | | the solution was used at |
| | | a low concentration.) |

<Plaque Assay>

| | | |
|---|---|---|
| Cell | M size (6 cm) dish was | Nunc 6 well plate was |
| culture | used to culture cells | used to culture cells |
| dish | | |
| Buffer | Phosphate buffered | Phosphate buffered |
| for | saline (PBS) was used. | saline (PBS), to which |
| washing | | calcium and magnesium |
| cells | | was added, was used. |
| | | (Cell separation was |
| | | prevented by calcium and |
| | | magnesium ions.) |
| Medium | A MEM medium | Gibco MEM (×10) medium |
| for | containing methyl | was used, wherein the |
| immobilization | cellulose at 5% as the | medium contained methyl |
| after | final concentration | cellulose at 3-5% as the |
| infection | was used. | final concentration. |

### <Method of Culturing CRFK Cells>

TABLE 7

| Operational Item | Example 10 | Example 11 |
|---|---|---|
| Washing culture | After removing the | Performed by the |
| cells | medium, cells were | same method as |
| | washed with | Example 10. |
| | phosphate buffered | |
| | saline (PBS), and | |
| | the PBS with which | |
| | the cells were | |
| | washed was | |
| | removed. | |
| \| | | |
| Collecting culture | 0.05% trypsin was | 0.025% trypsin was |
| cells | added and allowed | added. The trypsin |
| | to soak into all | and cells were |
| | the cells. About | reacted at 37° C. A |
| | 80% of the trypsin | Gibco MEM (×1) |
| | solution was | medium was added |
| | removed. The | for |
| | trypsin and cells | neutralization. |
| | were reacted at | After |
| | 37° C. An MEM medium | centrifugation, |
| | was added for | culture cells were |
| | neutralization. | collected and |
| | | suspended in the |
| | | Gibco MEM (×1) |
| | | medium, the number |
| | | of Cells was |
| | | measured with a |
| | | microscope. |
| \| | | |
| Culturing cells | A solution of | Collected cells |
| for plaque assay | collected cells | were diluted by |
| | was diluted | using a Gibco MEM |
| | 50-fold, 3 mL of | (×1) medium to be |
| | this suspension | 1.0 × 10⁵ cells/mL. |
| | solution diluted | 2 mL thereof was |
| | 50 Fold was added | added to each |
| | to each M size | 6-well plate. The |
| | dish. The cells | cells were |
| | were cultured for | cultured for four |
| | three days at 37° C. | days at 37° C. under |
| | under 5% carbon | 5% carbon dioxide |
| | dioxide condition. | condition. |
| | 50-fold was added | added to each |
| | to each M size | 6-well plate. The |
| | dish. The cells | cells were |
| | were cultured for | cultured for four |
| | three days at 37° C. | days at 37° C. under |
| | under 5% carbon | 5% carbon dioxide |
| | dioxide condition. | condition. |
| | 50-fold was added | added to each |
| | to each M size | 6-well plate. The |
| | dish. The cells | cells were |
| | were cultured for | cultured for four |
| | three days at 37° C. | days at 37° C. under |
| | under 5% carbon | 5% carbon dioxide |
| | dioxide condition. | condition. |

### <Plaque Assay>

TABLE 8

| Operational Item | Example 10 | Example 11 |
|---|---|---|
| Washing culture | After removing the | After removing the |
| cells | medium, cells were | medium, cells were |
| | washed with | washed with |
| | phosphate buffered | phosphate buffered |
| | saline (PBS), and | saline (PBS) |
| | the PBS with which | containing calcium |
| | the cells were | and magnesium, and |
| | washed was removed. | the PBS with which |
| | | the cells were |
| | | washed was removed. |
| \| | | |
| Viral infection | 0.5 mL of viral | 0.5 mL of viral |
| | solution or viral | solution or viral |
| | solution reacted | solution reacted |
| | with each of the | with each of the |
| | agents for | agents for |
| | neutralization | neutralization |
| | treatment is added | treatment is added |
| | to cells. Viruses | to cells and placed |
| | were allowed to | in a CO₂ incubator. |
| | infect the cells | Viruses were |
| | with a rocking | allowed to infect |
| | shaker for one hour | the cells while the |
| | | viral solution was |
| | | agitated every 1.5 |
| | | minutes for one |
| | | hour. |
| \| | | |
| Culturing cells for | The number of | Performed with the |
| plaque assay | plaques was counted | same method as |
| | by visual | Example 10. |
| | observation | |
| | following simple | |
| | staining with a | |
| | 0.5% (w/v) crystal | |
| | purple stain | |
| | containing 10% | |
| | formalin. | |

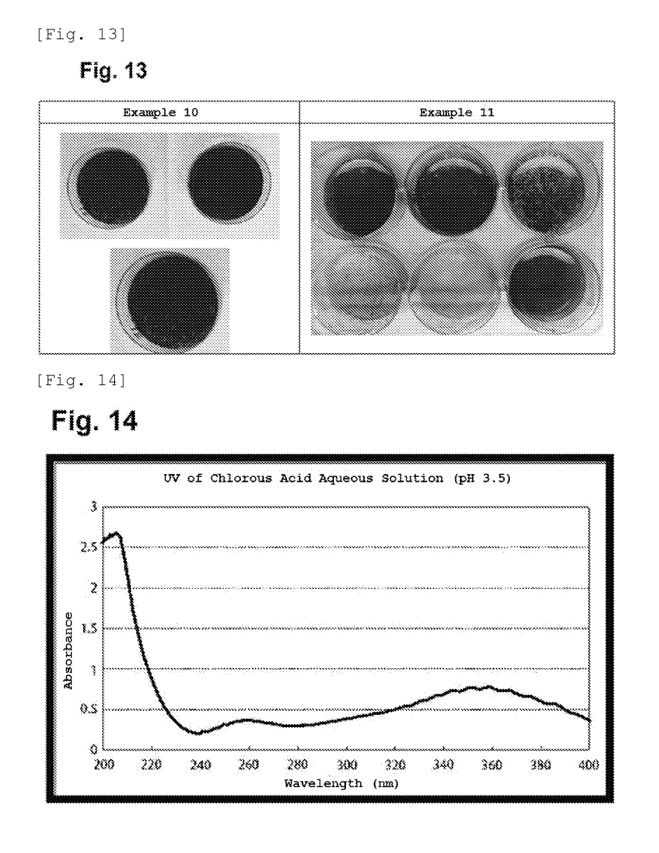

FIG. 13 shows pictures of plaques (Examples 10 and 11). Although it is not desired to be constrained by theory, it appears that there are more facilities that are capable of carrying out the method of Example 11.

### (In Vitro Test in Test Tube)

Inactivation effects of various sterilizing agents on feline caliciviruses when pH was unadjusted are shown as Result 1.

TABLE 9
(×log ± S.D CPU/mL)

| | | Concentration | Time of Contact (min) | | | |
|---|---|---|---|---|---|---|
| pH | Agent | (ppm) | 0 min | 1 min | 5 min | 10 min |
| 5.5 | Buffer | — | 5.4 ± 1.7 | 5.9 ± 2.3 | 5.2 ± 1.3 | 5.7 ± 2.3 |
| | (i) Chlorous Acid | 400 | 5.4 ± 1.7 | <2.0 | <2.0 | <2.0 |
| | Aqueous | 200 | 5.4 ± 1.7 | 3.4 ± 2.1 | <2.0 | <2.0 |
| | Solution | 100 | 5.4 ± 1.7 | >10⁶ | 3.6 ± 1.8 | <2.0 |
| | | 50 | 5.4 ± 1.7 | >10⁶ | >10⁶ | >10⁶ |
| | | 25 | 5.4 ± 1.7 | >10⁶ | >10⁶ | >10⁶ |
| | (ii) Chlorous Acid | 400 | 5.4 ± 1.7 | <2.0 | <2.0 | <2.0 |
| | Aqueous | 200 | 5.4 ± 1.7 | 3.6 ± 2.7 | 2.4 ± 2.1 | <2.0 |
| | Solution | 100 | 5.4 ± 1.7 | >10⁶ | 4.2 ± 2.3 | 3.2 ± 1.6 |
| | Formulation | 50 | 5.4 ± 1.7 | >10⁶ | >10⁶ | >10⁶ |
| | (AUTOLOC | | | | | |
| | Super) | | | | | |
| | (iii) Sodium | 400 | 5.4 ± 1.7 | <2.0 | <2.0 | <2.0 |
| | Hypochlorite | 200 | 5.4 ± 1.7 | >10⁶ | 3.7 ± 1.8 | 2.6 ± 1.8 |
| | | 100 | 5.4 ± 1.7 | >10⁶ | >10⁶ | >10⁶ |
| | | 50 | 5.4 ± 1.7 | >10⁶ | >10⁶ | >10⁶ |
| | | 25 | 5.4 ± 1.7 | >10⁶ | >10⁶ | >10⁶ |
| 6.5 | Buffer | — | 6.1 ± 2.1 | 5.2 ± 2.7 | 5.6 ± 1.9 | 4.9 ± 2.3 |
| | (i) Chlorous Acid | 400 | 6.1 ± 2.1 | <2.0 | <2.0 | <2.0 |
| | Aqueous | 200 | 6.1 ± 2.1 | 3.9 ± 2.8 | <2.0 | <2.0 |
| | Solution | 100 | 6.1 ± 2.1 | >10⁶ | 3.2 ± 2.5 | <2.0 |
| | | 50 | 6.1 ± 2.1 | >10⁶ | >10⁶ | >10⁶ |
| | | 25 | 6.1 ± 2.1 | >10⁶ | >10⁶ | >10⁶ |
| | (ii) Chlorous Acid | 400 | 6.1 ± 2.1 | <2.0 | <2.0 | <2.0 |
| | Aqueous | 200 | 6.1 ± 2.1 | >10⁶ | 3.4 ± 2.1 | <2.0 |
| | Solution | 100 | 6.1 ± 2.1 | >10⁶ | 3.1 ± 2.9 | <2.0 |
| | Formulation | 50 | 6.1 ± 2.1 | >10⁶ | >10⁶ | >10⁶ |
| | (AUTOLOC | | | | | |
| | Super) | | | | | |
| | (iii) Sodium | 400 | 6.1 ± 2.1 | <2.0 | <2.0 | <2.0 |
| | Hypochlorite | 200 | 6.1 ± 2.1 | >10⁶ | 3.3 ± 2.9 | <2.0 |
| | | 100 | 6.1 ± 2.1 | >10⁶ | >10⁶ | >10⁶ |
| | | 50 | 6.1 ± 2.1 | >10⁶ | >10⁶ | >10⁶ |
| | | 25 | 6.1 ± 2.1 | >10⁶ | >10⁶ | >10⁶ |
| 7.5 | Buffer | — | 5.2 ± 2.6 | 5.7 ± 1.5 | 5.3 ± 2.2 | 5.1 ± 1.3 |
| | (i) Chlorous Acid | 400 | 5.2 ± 2.6 | <2.0 | <2.0 | <2.0 |
| | Aqueous | 200 | 5.2 ± 2.6 | 3.3 ± 2.7 | <2.0 | <2.0 |
| | Solution | 100 | 5.2 ± 2.6 | >10⁶ | 3.8 ± 2.1 | <2.0 |
| | | 50 | 5.2 ± 2.6 | >10⁶ | >10⁶ | >10⁶ |
| | | 25 | 5.2 ± 2.6 | >10⁶ | >10⁶ | >10⁶ |
| | (ii) Chlorous Acid | 400 | 5.2 ± 2.6 | <2.0 | <2.0 | <2.0 |
| | Aqueous | 200 | 5.2 ± 2.6 | >10⁶ | 4.0 ± 1.6 | <2.0 |
| | Solution | 100 | 5.2 ± 2.6 | >10⁶ | 4.5 ± 2.3 | 4.2 ± 1.7 |
| | Formulation | 50 | 5.2 ± 2.6 | >10⁶ | >10⁶ | >10⁶ |
| | (AUTOLOC | | | | | |
| | Super) | | | | | |
| | (iii) Sodium | 400 | 5.2 ± 2.6 | <2.0 | <2.0 | <2.0 |
| | Hypochlorite | 200 | 5.2 ± 2.6 | 2.5 ± 1.8 | <2.0 | <2.0 |
| | | 100 | 5.2 ± 2.6 | >10⁶ | 3.4 ± 1.8 | <2.0 |
| | | 50 | 5.2 ± 2.6 | >10⁶ | 4.4 ± 1.8 | <2.0 |
| | | 25 | 5.2 ± 2.6 | >10⁶ | >10⁶ | >10⁶ |
| 8.5 | Buffer | — | 4.7 ± 2.8 | 5.2 ± 2.7 | 5.6 ± 1.9 | 4.9 ± 2.3 |
| | (i) Chlorous Acid | 400 | 4.7 ± 2.8 | <2.0 | <2.0 | <2.0 |
| | Aqueous | 200 | 4.7 ± 9.8 | 3.9 ± 2.8 | <2.0 | <2.0 |
| | Solution | 100 | 4.7 ± 2.8 | >10⁶ | 3.2 ± 2.5 | 2.7 ± 1.3 |
| | | 50 | 4.7 ± 2.8 | >10⁶ | >10⁶ | >10⁶ |
| | | 25 | 4.7 ± 2.8 | >10⁶ | >10⁶ | >10⁶ |
| | (ii) Chlorous Acid | 400 | 4.7 ± 2.8 | <2.0 | <2.0 | <2.0 |
| | Aqueous | 200 | 4.7 ± 2.8 | >10⁶ | 3.0 ± 2.1 | <2.0 |
| | Solution | 100 | 4.7 ± 2.8 | >10⁶ | 4.1 ± 2.1 | 3.3 ± 1.6 |
| | Formulation | 50 | 4.7 ± 2.8 | >10⁶ | >10⁶ | >10⁶ |
| | (AUTOLOC | | | | | |
| | Super) | | | | | |
| | (iii) Sodium | 400 | 4.7 ± 2.8 | <2.0 | <2.0 | <2.0 |
| | Hypochlorite | 200 | 4.7 ± 2.8 | 2.5 ± 2.3 | <2.0 | <2.0 |
| | | 100 | 4.7 ± 2.8 | 3.7 ± 2.6 | <2.0 | <2.0 |
| | | 50 | 4.7 ± 2.8 | 4.6 ± 3.2 | 3.5 ± 2.1 | <2.0 |
| | | 25 | 4.7 ± 2.8 | >10⁶ | >10⁶ | >10⁶ |

Many: Test segment where so many plaques could be confirmed such that the number of plaques could not be measured

Inactivation effects of various sterilizing agents on feline caliciviruses when pH was unadjusted are shown as Result 2.

TABLE 10
(×log ± S.D CPU/mL)

| | Concentration | Time of Contact (min) | | | |
|---|---|---|---|---|---|
| Agent | (ppm) | 0 min | 1 min | 5 min | 10 min |
| Antimicrobial | — | 6.4 ± 2.7 | 6.1 ± 2.1 | 6.3 ± 2.4 | 6.5 ± 1.8 |
| Aqueous Solution | | | | | |
| (i) Chlorous Acid | 400 | 6.4 ± 2.7 | <2.0 | <2.0 | <2.0 |
| Aqueous Solution | 200 | 6.4 ± 2.7 | 2.9 ± 2.2 | <2.0 | <2.0 |
| | 100 | 6.4 ± 2.7 | 2.5 ± 2.6 | <2.0 | <2.0 |
| | 50 | 6.4 ± 2.7 | >10⁶ | >10⁶ | >10⁶ |
| | 25 | 6.4 ± 2.7 | >10⁶ | >10⁶ | >10⁶ |
| (ii) Chlorous Acid | 400 | 6.4 ± 2.7 | <2.0 | <2.0 | <2.0 |
| Aqueous | 200 | 6.4 ± 2.7 | 3.6 ± 2.7 | <2.0 | <2.0 |
| Solution | 100 | 6.4 ± 2.7 | >10⁶ | 4.2 ± 2.3 | <2.0 |
| Formulation | 50 | 6.4 ± 2.7 | >10⁶ | >10⁶ | >10⁶ |
| (AUTOLOC | | | | | |
| Super) | | | | | |
| (iii) Sodium | 400 | 6.4 ± 2.7 | <2.0 | <2.0 | <2.0 |
| Hypochlorite | 200 | 6.4 ± 2.7 | <2.0 | <2.0 | <2.0 |
| | 100 | 6.4 ± 2.7 | <2.0 | <2.0 | <2.0 |
| | 50 | 6.4 ± 2.7 | 3.5 ± 2.1 | 2.9 ± 2.7 | <2.0 |
| | 25 | 6.4 ± 2.7 | >10⁶ | >10⁶ | >10⁶ |

(Sterilizing Solution Collected from Wringing Wet Wipe in which Nonwoven Fabric is Impregnated with Sterilizing Agent)

Next, inactivation effects of a sterilizing solution impregnated into a wet wipe on feline caliciviruses are shown as Result 3.

TABLE 11
(CPU/mL)

| | Dilution Factor | Time of Contact (min) | | | |
|---|---|---|---|---|---|
| Agent | (Concentration: ppm) | 0 min | 1 min | 5 min | 10 min |
| Antimicrobial | — | 8.0 × 10⁵ | 5.7 × 10⁵ | 1.2 × 10⁶ | 8.2 × 10⁵ |
| Aqueous | | | | | |
| Solution | | | | | |

| | | | | | |
|---|---|---|---|---|---|
| (ii) Chlorous | 3 | times (10000) | <100 | <100 | <100 |
| Acid Aqueous | 5 | times (6000) | <100 | <100 | <100 |
| Solution | 7.5 | times (4000) | <100 | <100 | <100 |
| Formulation | 10 | times (3000) | <100 | <100 | <100 |
| (AUTOLOC | 15 | times (2000) | 4.0 × 10² | <100 | <100 |
| Super) | 30 | times (1000) | 2.6 × 10³ | <100 | <100 |
| | 40 | times (750) | 3.8 × 10⁴ | 1.9 × 10⁴ | 1.8 × 10⁴ |
| | 60 | times (500) | >10⁶ | >10⁶ | >10⁶ |
| | 60 | times (500) | >10⁶ | >10⁶ | >10⁶ |
| (iii) Sodium | 3000 | ppm | <100 | <100 | <100 |
| Hypochlorite | 1000 | ppm | <100 | <100 | <100 |
| | 750 | ppm | <100 | <100 | <100 |
| | 500 | ppm | 3.5 ± 2.1 | 2.9 ± 2.7 | <100 |

Next, inactivation effects of a sterilizing solution collected from wringing a wet wipe stored at normal temperature (around 30° C.) on feline caliciviruses are shown as Result 4. As shown, at 4000 ppm, it is understood that viruses can be disinfected in 1 minute of contact even on day 20.

TABLE 12

| Days | | Dilution Factor | Time of Contact (min) | | | |
|---|---|---|---|---|---|---|
| Stored | Agent | (Concentration: ppm) | 0 min | 1 min | 5 min | 10 min |
| Day 0 | \textcircled{2} Chlorous | Undiluted Solution | 8.0 × 10⁵ | <100 | <100 | <100 |
| | Acid | (30000) | | | | |
| | Aqueous | 3 times (10000) | | <100 | <100 | <100 |
| | Solution | 5 times (6000) | | <100 | <100 | <100 |
| | Formulation | 7.5 times (4000) | | <100 | <100 | <100 |
| | (AUTOLOC | 10 times (3000) | | <100 | <100 | <100 |
| | Super) | 15 times (2000) | | 4.0 × 10² | <100 | <100 |
| | | 30 times (1000) | | 2.6 × 10³ | <100 | <100 |
| | \textcircled{3} Sodium | 3000 ppm | | <100 | <100 | <100 |
| | Hypochlorite | 1000 ppm | | <100 | <100 | <100 |
| Day 3 | \textcircled{2} Chlorous | Undiluted Solution | 1.1 × 10⁶ | <100 | <100 | <100 |
| | Acid | (30000) | | | | |
| | Aqueous | 3 times (10000) | | <100 | <100 | <100 |
| | Solution | 5 times (6000) | | <100 | <100 | <100 |
| | Formulation | 7.5 times (4000) | | <100 | <100 | <100 |
| | (AUTOLOC | 10 times (3000) | | 8.0 × 10² | <100 | <100 |
| | Super) | 15 times (2000) | | 2.3 × 10³ | <100 | <100 |
| | | 30 times (1000) | | Many | 4.1 × 10³ | 4.7 × 10³ |
| | \textcircled{3} Sodium | 3000 ppm | | Many | Many | Many |
| | Hypochlorite | 1000 ppm | | Many | Many | Many |
| Day 7 | \textcircled{2} Chlorous | Undiluted Solution | 1.4 × 10⁶ | <100 | <100 | <100 |
| | Acid | (30000) | | | | |
| | Aqueous | 3 times (10000) | | <100 | <100 | <100 |
| | Solution | 5 times (6000) | | <100 | <100 | <100 |
| | Formulation | 7.5 times (4000) | | <100 | <100 | <100 |
| | (AUTOLOC | 10 times (3000) | | Many | 6.1 × 10³ | 5.2 × 10³ |
| | Super) | 15 times (2000) | | Many | Many | Many |
| | | 30 times (1000) | | Many | Many | Many |
| Day 10 | \textcircled{2} Chlorous | Undiluted Solution | 8.1 × 10⁵ | <100 | <100 | <100 |
| | Acid | (30000) | | | | |
| | Aqueous | 3 times (10000) | | <100 | <100 | <100 |
| | Solution | 5 times (6000) | | <100 | <100 | <100 |
| | Formulation | 7.5 times (4000) | | <100 | <100 | <100 |
| | (AUTOLOC | 10 times (3000) | | Many | 8.1 × 10³ | 6.2 × 10³ |
| | Super) | 15 times (2000) | | Many | Many | Many |
| | | 30 times (1000) | | Many | Many | Many |
| Day 20 | \textcircled{2} Chlorous | Undiluted Solution | 3.1 × 10⁵ | <100 | <100 | <100 |
| | Acid | (30000) | | | | |
| | Aqueous | 3 times (10000) | | <100 | <100 | <100 |
| | Solution | 5 times (6000) | | <100 | <100 | <100 |
| | Formulation | 7.5 times (4000) | | <100 | <100 | <100 |
| | (AUTOLOC | 10 times (3000) | | Many | Many | Many |
| | Super) | 15 times (2000) | | Many | Many | Many |
| | | 30 times (1000) | | Many | Many | Many |

Many: Test segment where so many plaques could be confirmed such that the number of plaques could not be measured

As shown above, the chlorous acid aqueous solution formulation of the present invention is understood as exhibiting virucidal (action) on noroviruses.

### Example 12

### Inactivation Effect on Viruses in the Presence of Organic Matter

In the present Example, tests for examining inactivation effects on infectious viruses in the presence of an organic matter, which were designed assuming use in vomit treatment, were conducted. Each test was conducted to examine an inactivation effect from AUTOLOC Super at each concentration on viruses in an organic matter (10% miso solution).

### (Materials and Method)

### <Testing Method>

### (Materials)

1) Reagents that were used

“AUTOLOC Super”, 10 w/w % potassium iodide, 10% sulfuric acid, 0.1 M sodium thiosulfate, and hydrochloric acid

### 2) Preparation Method of Buffer

Phosphate buffered saline (Dulbecco's PBS; pH 7.4) was used. The solution was stored at 4° C. (refrigerator).

### 3) Preparation Method of 10% Miso

Homogeneous paste of commercially available miso was made with a mortar and the paste was adjusted to pH of 4 with hydrochloric acid. PBS in which viruses were homogeneously suspended was added to the miso solution to make a 10% miso solution for use in the tests.

### 4) Viruses and Cells

The feline calicivirus F4 strain was used, and CRFK cells were used as cells for culturing and quantifying the viruses.

The influenza virus Type A Aichi strain A/Aichi/68 (H3N2) was used, and MDCK cells were used as cells for culturing and quantifying the viruses.

Eagle's minimum essential medium (MEM) to which 5% fetal bovine serum (FBS) was added was used for culturing the cells. The cells were cultured at 37° C. for three days in the presence of 5% carbon dioxide. Cells that formed a monolayer culture layer on a petri dish were used.

### (Method)

### 1) Quantification of Number of Infectious Viruses

### Feline Caliciviruses

Quantification was performed by using a plaque assay. Viruses treated with various test solutions were diluted to a suitable viral concentration using Dulbecco's phosphate buffered saline (PBS) containing 0.5% FBS. 0.5 ml of said mixture was inoculated into a monolayer culture (5 cm petri dish) of CRFK cells. The viruses were adsorbed while mechanically rocking the viruses on a rocker platform for 60 minutes at room temperature.

For plaque formation, the CRFK cells after viral adsorption were cultured over night at 37° C. in a MEM containing 0.68% methyl cellulose and 0.5% FBS. After confirming that plaques were produced, the number of plaques was counted by visual observation following simple staining of cells in the petri dish with a 0.5% (w/v) crystal purple stain containing 10% formalin.

### Influenza Viruses

Quantification was performed by using a plaque assay. Viruses treated with various test solutions were diluted to a suitable viral concentration using Dulbecco's phosphate buffered saline (PBS) containing 0.1% bovine serum albumin (BSA). 0.5 ml of said mixture was inoculated into a monolayer culture (5 cm petri dish) of MDCK cells. The viruses were adsorbed while mechanically rocking the viruses on a rocker platform for 60 minutes at room temperature.

For plaque formation, the MDCK cells after viral adsorption were cultured for two days at 37° C. in a MEM containing 0.8% soft agar and acetylated trypsin (5 μg/ml). After confirming that plaques were produced, the number of plaques was counted by visual observation following simple staining of cells in the petri dish with a 0.5% (w/v) crystal purple stain containing 10% formalin.

### 2) Virus Inactivation

### Feline Caliciviruses

Each sample solution was stored in a refrigerator while being wrapped in aluminum foil. All operations were conducted on ice unless specifically noted otherwise.

Virus inactivation tests for “AUTOLOC Super” were conducted by preparation with distilled water to chlorous acid (HClO₂) concentrations of 10800 ppm, 8640 ppm, 7200 ppm, 6005 ppm, 4795 ppm, 3600 ppm, 2419 ppm, and 1209 ppm at the time of contact. The mixtures were then lightly agitated with a vortex mixer for homogenization.

After 10 μl of these solutions was added to 190 μl of feline calicivirus-containing 10% miso solution (about 10⁷ infectious unit/ml) so that the total amount is 200 μl, the mixture was further agitated to prepare a homogeneous viral solution to be subjected to testing. After maintaining moisture for 20 minutes at 25° C., the solution to be subjected to testing was immediately cooled in ice water while being suitably diluted with cold 0.5% FBS-added PBS to quantify the number of infectious viruses.

### Influenza Viruses

Each sample solution was stored in a refrigerator while being wrapped in aluminum foil. All operations were conducted on ice unless specifically noted otherwise.

Virus inactivation tests for “AUTOLOC Super” were conducted by preparation with distilled water to chlorous acid (HClO₂) concentrations of 16000 ppm, 14000 ppm, 11000 ppm, 10300 ppm, 8600 ppm, 6400 ppm, 4300 ppm, and 2100 ppm at the time of contact. The mixtures were then lightly agitated with a vortex mixer for homogenization. After 10 μl of these solutions was added to 190 μl of influenza virus-containing 10% miso solution (about 10⁷ infectious unit/ml) so that the total amount is 200 μl, the mixture was further agitated to prepare a homogeneous viral solution to be subjected to testing. After maintaining moisture for 20 minutes at 25° C., the solution to be subjected to testing was immediately cooled in ice water while being suitably diluted with cold 0.1% BSA-added PBS to quantify the number of infectious viruses.

### (Results)

Inactivation effects on feline caliciviruses in the presence of an organic matter are shown in the following Table.

### Table 13 Inactivation Effects on Feline Caliciviruses in the Presence of Organic Matter (10% Miso)

TABLE 13

| Chlorous Acid | |
|---|---|
| Concentration (ppm) | Residual Infectivity Titer |
| 0 | 0.9700 |
| 1209 | 0.9100 |
| 2419 | 0.5900 |
| 3600 | 0.1660 |
| 4795 | 0.0250 |
| 6005 | 0.0097 |
| 7200 | 0.0054 |
| 8640 | 0.0028 |
| 10800 | 0.0005 |

The numerical values are ratios of the amount of residual infectious viruses.
*With the result of measuring the amount of infectious viruses after being maintained in PBS (phosphate buffered saline) instead of the test sample solution for the same time and at the same temperature as “1.00”, ratios with respect to the amount of residual infectious viruses after inactivation in the test sample solution was calculated.

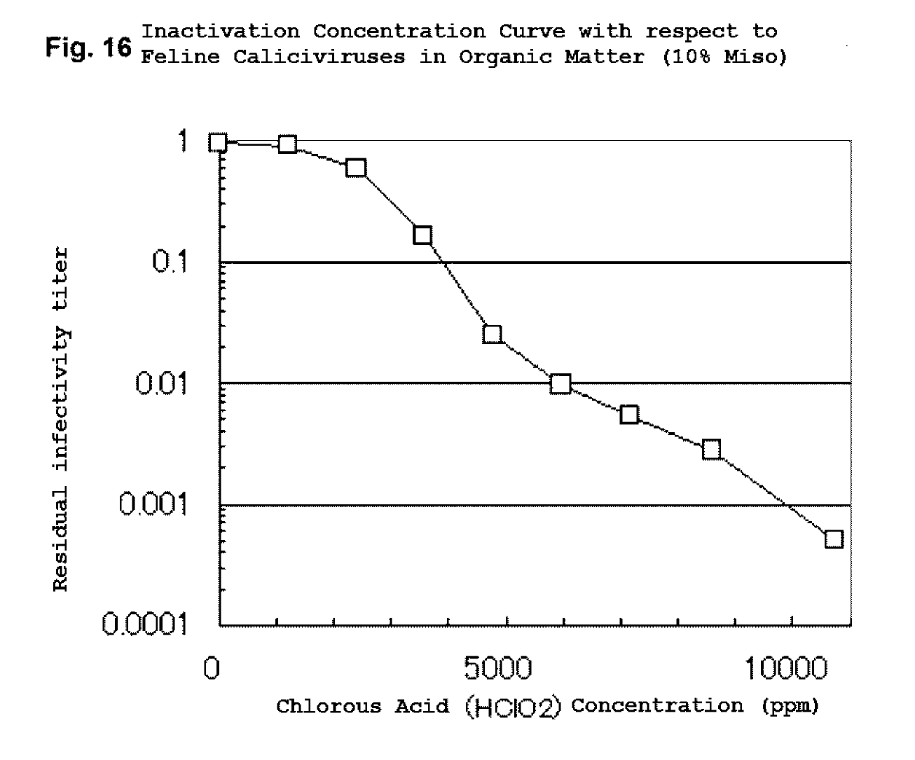

The chlorous acid aqueous solution formulation “AUTOLOC Super” of the present invention also exhibited virus inactivation action in an organic matter (10% miso). Such action was dependent on concentration. Feline caliciviruses were inactivated to less than 1/1000 at 10800 ppm. The inactivation concentration curve with respect to feline caliciviruses in an organic matter (10% miso) is shown in FIG. 16.

Inactivation effects on influenza viruses in the presence of an organic matter are shown in the following Table.

Table 14 Inactivation against Influenza Viruses in Organic Matter (10% Miso)

TABLE 14

| Chlorous Acid Concentration | |
|---|---|
| (ppm) | Residual Infectivity Titer |
| 0 | 0.900 |
| 2150 | 0.610 |
| 4300 | 0.370 |
| 6450 | 0.310 |
| 8600 | 0.120 |
| 10320 | 0.160 |
| 11610 | 0.120 |
| 14190 | 0.065 |
| 16340 | 0.020 |

The numerical values are ratios of the amount of residual infectious viruses. *With the result of measuring the amount of infectious viruses after being maintained in PBS (phosphate buffered saline) instead of the test sample solution for the same time and at the same temperature as “1.00”, ratios with respect to the amount of residual infectious viruses after inactivation in the test sample solution were calculated.

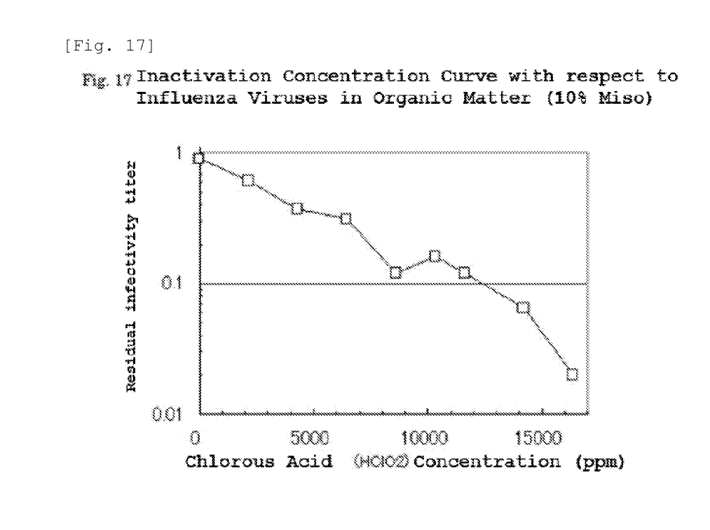

The chlorous acid aqueous solution formulation “AUTOLOC Super” of the present invention also exhibited virus inactivation action in an organic matter (10% miso). Such action inactivated influenza viruses in a concentration-dependent manner. The inactivation concentration curve with respect to influenza viruses in an organic matter (10% miso) is shown in FIG. 17.

As described above, the present invention is exemplified by the use of its preferred Embodiments and Examples. However, the present invention is not limited thereto. Various embodiments can be practiced within the scope of the structures recited in the claims. It is understood that the scope of the present invention should be interpreted solely based on the claims. Furthermore, it is understood that any patent, any patent application, and any references cited in the present specification should be incorporated by reference in the present specification in the same manner as the contents are specifically described therein.

### INDUSTRIAL APPLICABILITY

A virus disinfectant comprising a chlorous acid aqueous solution of the present invention can be utilized as a food additive, antiseptic, quasi-drug, medicine, or the like.

1.-13. (canceled)

14. A virus disinfectant comprising a chlorous acid aqueous solution, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the virus disinfectant is targeted for influenza viruses, wherein the virus disinfectant has pH of 6.5 or lower and comprises chlorous acid in a concentration of 200 ppm or higher.

15. A virus disinfectant comprising a chlorous acid aqueous solution, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the virus disinfectant is targeted for herpes viruses, wherein the virus disinfectant has pH of 5.5 or lower and comprises chlorous acid in a concentration of 50 ppm or higher.

16. A virus disinfectant comprising a chlorous acid aqueous solution, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the virus disinfectant is targeted for polioviruses, wherein the virus disinfectant has pH of 7.5 or lower and comprises chlorous acid in a concentration of 500 ppm or higher.

17. A virus disinfectant comprising a chlorous acid aqueous solution, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the virus disinfectant is targeted for noroviruses or feline caliciviruses, wherein the virus disinfectant comprises chlorous acid in a concentration of 400 ppm or higher.

18. The virus disinfectant of claim 14, wherein the chlorous acid aqueous solution has a significantly lower cytotoxic action even when compared at a concentration at which a virus disinfection effect of the chlorous acid aqueous solution is equivalent to a virus disinfection effect of sodium hypochlorite.

19. The virus disinfectant of claim 15, wherein the chlorous acid aqueous solution has a significantly lower cytotoxic action even when compared at a concentration at which a virus disinfection effect of the chlorous acid aqueous solution is equivalent to a virus disinfection effect of sodium hypochlorite.

20. The virus disinfectant of claim 16, wherein the chlorous acid aqueous solution has a significantly lower cytotoxic action even when compared at a concentration at which a virus disinfection effect of the chlorous acid aqueous solution is equivalent to a virus disinfection effect of sodium hypochlorite.

21. The virus disinfectant of claim 17, wherein the chlorous acid aqueous solution has a significantly lower cytotoxic action even when compared at a concentration at which a virus disinfection effect of the chlorous acid aqueous solution is equivalent to a virus disinfection effect of sodium hypochlorite.

22. The virus disinfectant of claim 14, for virus disinfection in the presence of an organic matter.

23. The virus disinfectant of claim 15, for virus disinfection in the presence of an organic matter.

24. The virus disinfectant of claim 16, for virus disinfection in the presence of an organic matter.

25. The virus disinfectant of claim 17, for virus disinfection in the presence of an organic matter.

26. An article impregnated with the virus disinfectant of claim 14 for viruses disinfection.

27. An article impregnated with the virus disinfectant of claim 15 for viruses disinfection.

28. An article impregnated with the virus disinfectant of claim 16 for viruses disinfection.

29. An article impregnated with the virus disinfectant of claim 17 for viruses disinfection.

30. The article of claim 26, wherein the article is selected from a sheet, film, patch, brush, nonwoven fabric, paper, fabric, absorbent cotton, and sponge.

31. The article of claim 27, wherein the article is selected from a sheet, film, patch, brush, nonwoven fabric, paper, fabric, absorbent cotton, and sponge.

32. The article of claim 28, wherein the article is selected from a sheet, film, patch, brush, nonwoven fabric, paper, fabric, absorbent cotton, and sponge.

33. The article of claim 29, wherein the article is selected from a sheet, film, patch, brush, nonwoven fabric, paper, fabric, absorbent cotton, and sponge.

34. A method for disinfecting influenza viruses, comprising a step of contacting chlorous acid aqueous solution with influenza viruses, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the solution has pH of 6.5 or lower and comprises chlorous acid in a concentration of 200 ppm or higher.

35. A method for disinfecting herpes viruses, comprising a step of contacting chlorous acid aqueous solution with herpes viruses, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the solution has pH of 5.5 or lower and comprises chlorous acid in a concentration of 50 ppm or higher.

36. A method for disinfecting polioviruses, comprising a step of contacting chlorous acid aqueous solution with polioviruses, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the solution has pH of 7.5 or lower and comprises chlorous acid in a concentration of 500 ppm or higher.

37. A method for disinfecting noroviruses or feline caliciviruses, comprising a step of contacting chlorous acid aqueous solution with noroviruses or feline caliciviruses, wherein the chlorous acid aqueous solution is prepared by adding one compound from inorganic acids, inorganic acid salts, organic acids, or organic acid salts, two or more types of compounds therefrom, or a combination thereof to an aqueous solution comprising chlorous acid (HClO₂), wherein the solution comprises chlorous acid in a concentration of 400 ppm or higher.
